(19) United States
(12) Patent Application Publication
(10) Pub. No.: US 2022/0328220 A1
(43) Pub. Date: Oct. 13, 2022

(54) RTB-Based Permanent Magnet Material, Preparation Method thereof, and Application thereof

(71) Applicants: XIAMEN TUNGSTEN CO., LTD., Fujian (CN); FUJIAN CHANGTING GOLDEN DRAGON RARE-EARTH CO., LTD, Fujian (CN)

(72) Inventors: Qingfang HUANG, Fujian (CN); Gang FU, Fujian (CN); Dakun CHEN, Fujian (CN); Jiaying HUANG, Fujian (CN); Deqin XU, Fujian (CN); Shaowei LIU, Fujian (CN)

(21) Appl. No.: 17/600,107

(22) PCT Filed: Jul. 7, 2020
(86) PCT No.: PCT/CN2020/100580

§ 371 Date: Sep. 30, 2021

(30) Foreign Application Priority Data
Dec. 24, 2019 (CN) 201911348776.1

(51) Int. Cl. H01F 1/057; B22F 3/24; B22F 9/04; C22C 38/00; C22C 33/02

(52) U.S. Cl. CPC H01F 1/0577; B22F 3/24; B22F 9/04; C22C 38/005; C22C 33/02; B22F 2003/248; B22F 2301/355; C22C 2202/02

(57) ABSTRACT

An RIB-based permanent magnet material, a preparation method thereof, and an application thereof. The RIB-based permanent magnet material comprises the following components: R′: 29.5 to 33.5 wt. %, wherein R′ comprises Pr, and the content of Pr is ≥8.85 wt. %; C:0.106 to 0.26 wt. %; O: ≤0.07 wt. %; X: 0 to 5.0 wt. %, wherein X is one or more of Cu, Al, Ga, Co, Zr, Ti, Nb and Mn; B:0.90 to 1.2 wt. %; and Fe:61.4 to 69.5 wt. %. The RIB-based permanent magnet material can improve the performance of a permanent magnet material without employing heavy rare earths. There is no need to control the content of carbon introduced in the process, and the magnet exhibits excellent performance even with a high carbon content.

### TECHNICAL FIELD

The present disclosure relates to an RTB-based permanent magnet material, a preparation method thereof, and an application thereof.

### BACKGROUND

Since the Soviet scientists discovered Nd₂Fe₁₄B in 1979, the researchers in the United States and Japan took the lead in the study of the properties of the phase, the phase composed of PrNd (the mass ratio of Pr to Nd is 20:80 or 25:75) has been applied to the production of sintered permanent magnet in commercial at present, due to its advantages such as high magnetic energy product and high remanent magnetism, at present it has been widely used in motor, electroacoustic device, computer hard disk drive (HDD), military equipment, human nuclear magnetic resonance imaging (MRI), microwave communication technology, controller, instrument and so on.

With the progress of science and technology, higher requirements has been put forward for the performance of Nd—Fe—B, many researchers has improved e performance of neodymium-iron-boron magnet material by adding a large number of heavy rare earth Dy or Tb, however, excessive use of heavy rare earths will dramatically increase the cost of materials, and at the same time, the resources of heavy rare earths are relatively few.

Therefore, the technical problem to be solved urgently in this field is how to make use of the elements with abundant resources to obtain the neodymium-iron-boron material with high coercivity and high remanence.

In addition, how to achieve high uniformity and stability of magnetic properties of mass-produced magnets and control the production cost at the same time is also a problem that has been committed to solving in this field. However, carbon, sulfur, hydrogen, oxygen, nitrogen and other impurities will be inevitably introduced into the neodymium-iron-boron magnet material in the process, which poses a great challenge to the production of magnets with uniform and stable magnetic properties. In addition, itis generally believed in this field that the high content of carbon impurities will lead to the uneven grain size of the magnet's main phase and the uneven distribution of neodymium-rich phase, resulting in the decrease of various performance indexes of the magnet in different degrees. Therefore, in order to improve the uniformity stability of magnets, the production process need to be strictly controlled,

### Content of the Present Invention

The technical problem to be solved in the present invention is for overcoming the defects that the performance improvement of sintered neodymium-iron-boron magnet is excessively dependent on heavy rare earth elements in the prior art, while the high content of carbon element in sintered neodymium-iron-boron magnet will lead to the decrease of the performance of the magnet. Instead, the present invention provides an RIB-based permanent magnet material and a preparation method and an application thereof. The RTB-based permanent magnetic material provided by the invention can realize the improvement of the performance of permanent magnetic materials irr the absence of heavy rare earth, and it is not necessary to control the content of carbon elements introduced in the process. Under the condition of high carbon content, the magnet still maintains excellent performance.

The present invention provides an RIB-based permanent magnet material, which comprises the following components by mass percentage:

R′: 29.5-33.5 wt. %, wherein: R′ is a rare earth element and R′ comprises Pr; the content of Pr is ≥8.85 wt. %;

### C: 0.106-0.26 wt. %;

### O: ≤0.07 wt. %;

X: 0-5.0 cwt. %, X is one or more of Cu, Zr, Ti, Nb and Mn;

### B: 0.90-1.2 wt. %;

### Fe: 61.4-69.5 wt. %.

In the present invention, the content of R′ is 29.5-33.4 wt. %, such as, 29.5 wt. %, 30.5 wt. %, 30.8 wt. %, 31.0.%, 31.013 wt. %, 31.075 wt. %, 31.115 wt. %, 31.5 wt. %, 32.0 wt. %, 32.3 wt. %, 32.8 wt. % or 33.3 wt. %, the percentage refers to the mass percentage in the RIB-based permanent magnet material.

In the present invention, the content of Pr is preferably 8.85-27.15 wt. %, more preferably ≥17.00 wt. %, such as, 8.846 wt. %, 8.848 wt. %, 8.849 wt %, 8.851 wt. %, 9,852 wt. %, 10.148 wt. %, 10.151 wt. %, 10.848 wt. %, 10,849 wt. %, 11,848 wt. %, 12.148 wt. %, 12.15 wt. %. 12.151 wt. %, 13.149 wt. %, 14.147 wt. %, 14.148 wt. %, 14.149 wt. %, 14.151 wt. %, 14.152 wt. %, 16.148 wt. % 16.151 wt. %, 16.152 wt. %, 17.148 wt. %, 17.149 wt. %, 17.15 wt. %, 17,151 wt. %, 17.152 wt. %, 18.148 wt. %, 18.149 wt. %, 18.151 wt. %, 18.152 wt. %, 19.148 wt. %, 19.149 wt. %, 19.15 wt. %, 19.151 wt. %, 19.152 wt. %, 20.148 wt. %, 20.149 wt %, 20.15 wt. %, 20.152 wt. %, 21,148 wt. %, 22.149 wt. %, 22.151 wt. %, 23.149 wt. %, 23.15 wt. %, 24,148 wt. %, 24.151 wt. %, 24,152 wt. %, 25.152 wt. % or 27.148 wt. %, the percentage refers to the mass percentage in the RTB-based permanent magnet material.

In the present invention, R′ can further comprise Nd and/or R, R is a rare earth element besides Pr and Nd.

Wherein, the content of Nd is preferably 3.3-23.0 wt. %, such as, 3.348 wt. %, 5,352 wt. %, 6.652 wt. %, 6.851 wt. %, 7.351 wt. %. 7.353 wt. %, 7.849 wt. %, 8.351 wt. %, 8.651 wt. %, 8.652 wt. %, 8.852 wt. %, 9.349 wt. %, 9.352 wt. %, 10.651 wt. %, 10.851 wt. %, 11.348 wt. %, 11.351 wt. %, 11.352 wt. %, 11.651 wt. %, 11,652 wt. %, 11.851 wt. %, 12,351 wt. %, 12.352 wt. %, 12.649 wt. %, 12.65 wt. %, 12.651 wt. %. 12.652 wt. %, 13.348 wt. %, 13.352 wt. %, 13.353 wt. %, 13.649 wt. %, 13.651 wt. %, 13.653 wt. %, 13.848 wt. %, 13.852 wt. %, 14.348 wt. %, 14.35 wt. %, 14.351 wt. %, 14.352 wt. %, 14.355 wt. %, 14.652 wt. %, 14.849 wt. %, 15.352 wt. %, 15.353 wt. %, 16,349 wt. %, 16.35 wt. %, 16.651 wt. %, 16.848 wt. %, 17.352 wt. %, 17.652 wt. %, 18.335 wt. %, 18.651 wt. %. 18.652 wt. %, 18.849 wt. %, 19.351 wt. %, 19.649 wt. %, 19.652 wt. %, 20.652 wt. %, 20.851 wt. %, 21.353 wt. %, 21.647 wt. %, 21.648 wt. %, 21,649 wt. %, 21.951 wt. %, 22.149 wt. % or 22.652 wt. %, the percentage refers to the mass percentage in the RTB-based permanent magnet material.

Wherein, the mass ratio of Nd to R′ is preferably ≤0.72, more preferably <0.5; such as, 0.110, 0.175, 0.216, 0.221, 0.233, 0.241, 0.253, 0.281, 0.283, 0.286, 0.297, 0.307, 0.317, 0.346, 0.350, 0.360, 0.366, 0.372, 0.378, 0.382, 0.285, 0.392, 0.395, 0.411, 0.416, 0.422, 0.424, 0.438, 0.443, 0.447, 0.456, 0.470, 0.476, 0.479, 0.487, 0.520, 0,536, 0.541, 0.544, 0.551, 0.554, 0,588, 0.598, 0.601, 0.606, 0.608, 0.614, 0.632, 0.644, 0.666, 0,671, 0.673, 0.678, 0.696, 0.697, 0.700, 0.710, 0.713, 0.714, 0.715 or 0.719.

Wherein, the kind of R is preferably and/or Ce.

Wherein, the content of R is preferably 0-1 wt. %, such as, 0.29 wt. %, the percentage refers to the mass percentage in the RIB-based permanent magnet material.

In the present invention, R′ can further comprise a heavy rare earth element RH.

Wherein, the kind of RH can be Dy and/or Tb.

Wherein, the content of RH can be the conventional content in this field, the content of RH is preferably 0.5-2.6 wt. %, such as 0.58 wt. % 0.62 wt. %, 1.212 wt. %, 1.219 wt. %, 1.51 wt. %, 1.991 wt. %, 2.011 wt. %, 2.511 wt. % or 2.512 wt. %, the percentage refers to the mass percentage of the RTB-based permanent magnet material.

Wherein, the mass ratio of RH to R is preferably <0.253, for example 0.019-0.075, such as 0.019, 0.020, 0.038, 0.039, 0.047, 0.061 or 0.075.

When the RH comprises Tb, the content of Tb is preferably 0.5-2.0 wt. %, such as L991 wt. %, 1,212 cwt. %, 1.219 wt. % or 0.58 wt. %, the percentage refers to the mass percentage in the RIB-based permanent magnet material.

When the RH comprises Dy, the content of Dy is preferably 0.6-2.52 wt. %, such as 0.62 wt %, 1.51 wt %, 2.011 wt. %, 2.511 wt %, or 2.512 wt. %, and the percentage refers to the mass percentage in the RTB-based permanent magnet material.

In the present invention, the content of C is 0.106-0.25 wt. %, such as, 0.1062 wt. %, 0.1069 wt. %, 0.1072 wt. %, 0.1075 wt. %, 0.1251 wt. %, 0.1253 Wt. %, 0.1256 wt. %, 0.1532 wt. %, 0.1534 wt. %, 0.1537 wt. %, 0.1759 wt. %, 0.1761 wt. %, 0.1764 wt. %, 0.1835 wt. %, 0,184 wt. %, 0.1843 wt. %, 0.1846 wt. %, 0.1965 wt. %, 0.197 wt. %, 0.1973 wt. %, 0.2139 wt. %, 0.2144 wt. %, 0.2147 wt. %, 0.2243 wt. %, 0.2245 wt. %, 0.2248 wt. %, 0.2251 wt. %, 0.2379 wt. % or 0.2456 wt. %, the percentage refers to the mass percentage in the RIB-based permanent magnet material.

In the present invention, the content of O is ≤0.0691 cwt. %, such as 0.0382 wt. %, 0.0384 wt. %, 0.039 wt. %, 0.0391 wt. %, 0.041 wt. %, 0.0412 wt. %, 0.0432 wt. %, 0.0442 wt. %, 0.0444 wt. %, 0.0456 wt. %, 0.0458 wt. %, 0.0468 wt. %, 0.0492 wt. %, 0.0493 wt %, 0.0494 wt. %. 0.05 wt. %, 0.0501 wt. %. 0.0503 wt. %, 0.0523 wt. %, 0.0529 wt %, 0.0531 wt. %, 0.0558 wt. %, 0.0564 wt. %, 0.0566 wt. %, 0.0582 wt. %, 0.0588 wt. %, 0,059 wt. %, 0.0635 wt. %, 0.0641 wt. %, 0.0643 wt. %, 0.0669 wt. %, 0.0675 wt. %, 0.0685 wt. % or 0.0691 wt. %, the percentage refers to the mass percentage in the RIB-based permanent magnet material.

In the present invention, the content of B is 0.94-1.1 wt. %, such as, 0.946 wt. %, 0.947 wt. %, 0.948 wt. %, 0,949 wt. %, 0,951 wt. %, 0.952 wt. %. 0.958 wt. %, 0.961 wt. %, 0.962 wt. %, 0,981 wt. %, 0.982 wt. %, 0.985 wt. %, 0.998 wt. %, 1.008 wt. %, 1.009 wt. %, 1.01 wt. %, 1.011 wt. % or 1,012 wt. %, the percentage refers to the mass percentage in the RTB-based permanent magnet material.

In the present invention, the content of Fe is 61.4-69.3 wt. %, such as, 61.49 wt. %, 61.60 wt. %, 62.15 wt. %, 62.19 wt. %, 62.66 wt. %, 62.91 wt. %, 63.52 wt. %, 63.62 wt. %, 63.66 wt. %, 64.71 wt. %, 65.85 wt. %, 66.02 wt. %, 66.15 wt. %, 66.19 wt. %, 66.22 wt. %, 66.23 wt. %, 66.30 wt. %, 66.37 wt. %, 66.40 wt. %, 66.44 wt. %, 66.57 wt. %, 66.66 wt. %, 66.70 wt. %, 66.72 wt. %, 66.75 wt. %, 66.82 wt. %, 66.85 wt. %, 66.88 wt. %, 66.91 wt. %, 66.94 wt. %. 66.95 wt. %, 66.98 wt. %, 67.08 wt. %, 67.15 wt. %, 67.17 wt. %, 67.23 wt. %, 67.27 wt. %, 67.29 wt. %, 67.30 wt. %, 67.31 wt. %, 67.32 wt. %, 67.34 wt. %, 67.40 wt. %, 67.42 wt. %, 67.47 wt. %, 67.48 wt. %, 67.54 wt. %, 67.64 wt. %, 67.65 wt. %, 67.69 wt. %, 67.71 wt. %, 67.74 wt. %, 67.78 wt. %, 67.80 wt. %, 68.22 wt. %, 68.24 wt. %, 68.25 wt. %, 68.27 wt. %, 68.28 wt. %, 68.31 wt. %, 68.32 wt./, 68.34 wt. %, 68.36 wt. %, 68.73 wt. %, 68.83 wt. %, 68.95 wt. %, 69.03 wt. %, 69.10 wt. % or 69.25 wt. %, the percentage refers to the mass percentage in the RTB-based permanent magnet material.

In the present invention, X can be Cu, Al, Ga, Co, Zr, Ti or Nb, can also be “Cu and Al”, “Ga and Mn” “Cu. Al and Ga”, “Cu, Al, Ga and Zr”, “Cu, Al, Ga and Co” or “Cu Al, Ga, Zr and Co”.

In the present invention, the content of X is preferably 0-4.5 wt. %, such as, 0.021 wt. %, 0.041 wt. %, 0,101 wt. %, 0.102 wt. %. 0.201 wt. %, 0.202 wt. %, 0.251 wt. %, 0,301 wt. %, 0,302 wt. %, 0.351 wt. %, 0.352 wt. %, 0.362 wt. %, 0.401 wt. %, 0.421 wt. %, 0.423 wt. %, 0.451 wt. %, 0.497 wt. %, 0.5 wt. %, 0.501 wt. %, 0.523 wt. %, 0.526 wt. %, 0.601 wt. %, 0.602 wt. %, 0.643 wt. %, 0,673 wt. %, 0.702 wt. %, 0.704 wt. %, 0.743 wt. %, 0.801 wt. %, 0.803 wt. %, 0.871 wt. %, 0.882 wt. %, 0.894 wt. %, 0.901 wt. %, 0.945 wt. %, 1.021 wt. %, 1.022 wt. %, 1.105 wt. %, 1.194 wt. %, 1,274 wt. %, 1.305 wt. %, 1.402 wt. %, 1,506 wt. %, 1.562 wt. %. 1.732 wt. %, 1.905 wt. %, 2.501 wt. %, 3,803 wt. %, 3,809 wt. %, 3.813 wt. %, 3.814 wt. %, 3.865 wt. %, 3.959 wt. %, 4.199 wt. %, 4.207 wt. % or 4.208 wt. %, the percentage refers to the mass percentage in the RTB-based permanent magnet material.

When X comprises Cu the content of Cu is preferably 0.2-0.51 wt. %, such as, 0.201 wt. %, 0.302 wt. %, 0.34 wt. %, 0.341 wt. %, 0.351 wt. %, 0.381 wt. %, 0.382 wt. %, 0.4 wt. %, 0.401 wt. %, 0.402 wt. %, 0.403 wt. %, 0.41 wt. %, 0.42 wt. %, 0.421 wt. %, 0.441 wt. %, 0,451 wt. %, 0.5 wt. %, 0.501 wt. % or 0.502 wt. %, the percentage refers to the mass percentage in the RTB-based permanent magnet material.

When X comprises Al, the content of Al is preferably 0-0.81 wt. %, but not 0, for example, 0.01-0.03 wt. % or 0.5-0.8 wt. %, such as 0.01 wt. %, 0.021 wt. %, 0.03 wt. %, 0.041 wt. %, 0.042 wt. %, 0.101 wt. %, 0.102 wt. %, 0.103 wt. %, 0.202 wt. %, 0,298 wt. %, 0.301 wt. %, 0.302 wt. %, 0.351 wt. %, 0.401 wt. %, 0.402 wt. %, 0.403-t,%, 0,451 wt. %, 0,497 wt. %, 0.501 wt. %, 0.502 wt. %, 0.601 wt. %, 0.602 wt. %, 0.70 wt. 2%, 0.801 wt. %, 0.802 wt. % or 0.81 wt. %, the percentage refers to the mass percentage in the RTB-based permanent magnet material.

When X comprises Ga, the content of Ga is preferably 0.01.85 wt. %, but not 0, more preferably 0.1-1.552 wt. %, such as 0.102 wt. %, 0.151 wt. %, 0.202 wt. %, 0.251 wt. %, 0.3 wt. %, 0.301 wt. %, 0,302 wt. %, 0.399 wt. %, 0,401 wt. %, 0.42 wt. %, 0.421 wt. %, 0.501 wt. %, 0.502 wt. %, 0.901 wt. %, 1.402 wt. % or 1.552 wt. %, the percentage refers to the mass percentage in the RTB-based permanent magnet material.

When X comprises Co, the content of Co is preferably 0.0-3.0 wt. %, but not 0, more preferably 0.5-2.5 wt. %, such as 0.5 wt. %, 1.0 wt. % or 2.5 wt. %, the percentage refers to the mass percentage in the RTB-based permanent magnet material.

When X comprises Zr, the content of Zr is preferably 0.25-0.35 wt. %, such as 0.25 wt. %, 0.30 wt. % or 0.35 wt. %, the percentage refers to the mass percentage in the RTB-based permanent magnet material.

When X comprises Nb, the content of Nb is preferably 0.25-0.35 wt. %, such as 0.25 wt. %, 0.30 wt. % or 0.35 wt. %, the percentage refers to the mass percentage in the RTB-based permanent magnet material.

When X comprises Mn, the content of Mn is preferably 0.0-0.03 wt. %, but not 0, such as 0.01 wt. %, the percentage refers to the mass percentage in the RTB-based permanent magnet material.

In the present invention, the RIB-based permanent magnet material can further comprise conventional added element M, and for example, NI is one or more selected from the group consisting of Ni, Zn, Ag, In, Sn. Bi, V, Cr, Hf, Ta, and W.

Wherein, the kind of M is preferably Cr.

Wherein, the content of M is preferably 0-0.15 wt. %, but not 0, such as 0.05 wt. % or 0.12 wt. %, the percentage refers to the mass percentage in the RTB-based permanent magnet material.

In the present invention, the RTB-based permanent magnet material can further comprise nitrogen element N, preferably, the content of N is ≤0.05 wt. %, such as 0.0182 wt. %, 0.0187 wt. %, 0.0223 wt. %, 0.0228 wt. %, 0.025wt. %, 0.0251 wt. %, 0.0256 wt. %, 0.0284 wt. %, 0.0285 wt. %, 0.029 wt. %, 0.0301 wt. %, 0.0302 wt. %, 0.0307 wt. %, 0.0341 wt. %, 0.0342 wt. %, 0.0347 wt. %, 0.0366 wt. %, 0.0371 wt. %, 0.0372 wt. %, 0.0375 wt. %, 0.0378 wt. %, 0.0397 wt. %, 0.0398 wt. %, 0.0401 wt. %, 0.0404 wt. %, 0.0436 wt. %, 0.0439 wt. %, 0.0442 wt. %, 0.0455 wt. %, 0.0458 wt. %, 0.0461 wt. %, 0.0476 wt. %, 0.0482 wt. %, 0.0485 wt. % or 0.0486 wt. %, the percentage refers to the mass percentage in the RIB-based permanent magnet material.

In a preferred embodiment of the present invention, the RIB-based permanent magnet material comprises the following components: R′: 29.5-33.5 wt. %, Pr≥8.85 wt. %, C: 0.106-0.25 wt. %, 0: ≤0.0 wt. %, B: 0.94-1.1 wt. %, Fe: 61.4-69.3 wt. %, the percentage refers to the mass percentage in the RIB-based permanent magnet material.

In a preferred embodiment of the present invention, the RTB-based permanent magnet material comprises the following components: R′: 29.5-33.5 wt. %, Pr≥8.85 wt. %, C: 0.106-0.25 wt. %, O: ≤0.07 wt. %, Cu: 0.2-0.51 wt. %, B: 0.94-1.1 wt. %, Fe: 61.4-69.3 wt. %, the percentage refers to the mass percentage in the RIB-based permanent magnet material.

In a preferred embodiment of the present invention, the RIB-based permanent magnet material comprises the following components: R′: 29.5-33.5 wt. %, Pr≥8.85 wt. %, C: 0.106-0.25 wt. %, O: ≤0.07 wt. %, Al: 0-0.81 wt. %, but not 0 B: 0.94-1.1 wt. %, Fe: 61.4-69.3 wt. %, the percentage refers to the mass percentage in the RIB-based permanent magnet material.

In a preferred embodiment of the present invention, the RIB-based permanent magnet material comprises the following components: 29.5-33.5 wt. %, Pr≥8.85 wt. %, C:0.106-0.25 wt. %, 0: ≤0.07 wt. %, Ga: 0.1-1.85 wt. %, B: 0.94-1.1 wt. %, Fe: 61.4-69.3 wt. %, the percentage refers to the mass percentage in the RTB-based permanent magnet material.

In a preferred embodiment of the present invention, the RIB-based permanent magnet material comprises the following components: R′: 29.5-33.5 wt. %, Pr≥8.85 wt. %, C: 0.106-0.25 wt. %, 0: ≤0.07 wt. %, Co: 0.0-3.0 wt. %, but not 0, B: 0.94-1.1 wt. %, Fe: 61.4-69.3 wt. %, the percentage refers to the mass percentage in the RIB-based permanent magnet material.

In a preferred embodiment of the present invention, the RIB-based permanent magnet material comprises the following components: R′: 29.5-33.5 wt. %, Pr≥8.85 wt. %, C:0.106-0.25 wt. %, 0: ≤0.07 wt. %, Zr: 0.25-0.35 wt. %, B: 0.94-1.1 wt. %, Fe: 61.4-69.3%, the percentage refers to the mass percentage in the RTB-based permanent magnet material.

In a preferred embodiment of the present invention, the RIB-based permanent magnet material comprises the following components: W: 29.5-33.5 wt. %, Pr≥8.85 wt. %, C: 0.106-0.25 wt. %, 0: ≤0.07 wt. %, Nb: 0.25-0.35 wt. %, B: 0.94-1.1 wt. %, Fe: 61.4-69.3 wt. %, the percentage refers to the mass percentage in the RTB-based permanent magnet material.

In a preferred embodiment of the present invention, the RTB-based permanent magnet material comprises the following components: R′: 29.5-33.5 wt. %, Pr≥8.85 wt. %, C: 0.106-0.25 wt. %, 0: ≤0.07 wt. %, Cu: 0.34-0.51 wt. %, Al: 0-0.81 wt. %, but not 0, B: 0.94-1.1 wt. %, Fe: 61.4-69.3 wt. %, the percentage refers to the mass percentage in the RIB-based permanent magnet material.

In a preferred embodiment of the present invention, the RTB-based permanent magnet material comprises the following components: 29.5-33.5 wt. %, Pr≥8.85 wt. %, C: 0.106-0.25 wt. %, O: ≤0.07 wt. %, Cu: 0.34-0.51 wt. %, Al: 0-0.81 wt. %, but not 0, Ga: 0.1-0.5 wt. %, B: 0.94-1.1 wt. %, Fe: 61.4-69.3 wt. % the percentage refers to the mass percentage in the RTB-based permanent magnet material.

In a preferred embodiment of the present invention, the RTB-based permanent magnet material comprises the following components: R′: 29.5-33.5 wt. %, Pr≥8.85 wt. %, C: 0.106-0.25 wt. %, 0: ≤0.07 wt. %, Cu: 0.34-0.51 wt. %, Al: 0.25-0.81 wt. %, Ga: 0.1-0.42 wt. %, Zr: 0.25-0.30 wt. %, B: 0.94-1.1 wt. %, Fe: 61.4-69.3 wt. % the percentage refers to the mass percentage in the RTB-based permanent magnet material.

In a preferred embodiment of the present invention, the RIB-based permanent magnet material comprises the following components: R: 29.5-33.5 wt. %, Pr≥8.85 wt. %, C:0.106-0.25 wt. %, 0: ≤0.07 wt. %, Cu: 0.34-0.51 wt. %, Al: 0.25-0.81 wt. %, Ga: 0.1-0.41 wt. %, Co: 0.0-3.0 wt. %, Zr: 0.25-0.30 wt. %, Cr: 0.05-0.12 wt. %, B: 0.94-1.1 wt. %, Fe: 61.4-69.3 wt. %, the percentage refers to the mass percentage in the RTB-based permanent magnet material.

In a preferred embodiment of the present invention, the RTB-based permanent magnet material comprises the following components: 29.5-33.5 wt. %, Pr≥8.85 wt. %, RH: 0.5-2.6 wt. %, C: 0.106-0.25 wt. %, O: ≤0.07 wt. %, Cu: 0.34-0.51 wt. %, Al: 0.25-0.81 wt. %, Ga: 0.1-0.41 wt. %, Co: 0.0-3.0 wt. %, Zr: 0.25-0.30 wt. %, B: 0.94-1.1 wt. %, Fe: 61.4-69.3 wt. %, the percentage refers to the mass percentage in the RIB-based permanent magnet material.

In a preferred embodiment of the present invention, the RIB-based permanent magnet material comprises the following components: R′: 29.5-33.5 wt. %, Pr≥8.85 wt. %, Ce: 0-1 wt. %, RH: 0.5-2.6 wt. %, C: 0.106-0.25 wt. %, O: ≤0.07 wt. %, Cu: 0.34-0.51 wt. %, Al: 0.25-0.81 wt. %, Ga: 0.1-0.41 wt. %, Co: 0.0-3.0 wt. %, Zr: 0.25-0.30 wt. %, B: 0.94-1.1 wt. %, Fe: 61.4-69.3 wt. %, the percentage refers to the mass percentage in the RIB-based permanent magnet material.

In the present invention, the RIB-based permanent magnet material generally includes a main phase, a grain boundary phase, and an intergranular triangle region, wherein, the intergranular triangle region is also called rare earth-rich phase.

Wherein, preferably, the percentage of the volume of the intergranular triangle region with respect to the sum of the volume of the “main phase, the grain boundary phase and the intergranular triangle region” is such as 3.2%, 3.3%, 3.7%, 4.6%, 4.8% or 5.3%.

Wherein, preferably, the content of rare earth elements in the intergranular triangle region is 84.35-85.85%, such as 84.35%, 84.8%, 84.9%, 85%, 85.2%, 85.3%, 85.4% or 85.85%, and the percentage refers to the mass percentage in the total mass of elements in the intergranular triangle region.

Wherein, preferably, the content of 0 element in the intergranular triangle regions is 13.25-14.8%, such as 13:25%, 13.7%, 14.2%, 14.3%, 14.4%, 14.5%, 14.6%, 14.7%, 14.75% or 14.8%, the percentage refers to the mass percentage in the total mass of the elements in the intergranular triangle region.

When the RIB-based permanent magnet material includes Cu, preferably, in the intergranular triangle region, the content of Cu element is 0.6-0.9%, such as 0.6, 0.8 or 0.9%, and the percentage refers to the mass percentage in the total mass of the elements in the intergranular triangle region.

When the RIB-based permanent magnet material includes Ga, preferably, in the intergranular triangle region, the content of Ga elements is 0.4-0.6%, such as 0.4% or 0.6%, and the percentage refers to the mass percentage in the total mass of the elements in intergranular trigonal region.

When the RIB-based permanent magnet material includes Cu and Ga, preferably, in the intergranular triangle region, the content of Cu element is 0.3-0.4% and the content of Ga element is 0.5-0.6% such as 0.3% Cu, 0.6% Ga, 0.4% Cu, 0.4% Ga, 0.4% Cu, 0.5% Ga, or, 0.4% Cu, 0.6% Ga, the percentage refers to the mass percentage in the total mass of the elements in the intergranular triangle region.

The present invention further provides a preparation method for RTB-based permanent magnet material, which comprises the following steps: the molten liquid of the raw material composition of the RTB-based permanent magnet material is subjected to casting, hydrogen decrepitation and pulverization to obtain a powder, and the powder is mixed with dispersant, and then pressed, formed, sintered and aged; wherein:

(1) the raw material composition of RIB-based permanent magnet material comprises the following components by mass percentage:

R′: 29.5-33.5 wt. %, is a rare earth element, R′ comprises Pr, the content of Pr is ≥8.85 wt. %;

X: 0-5.0 wt. %, X is one or more selected from the group consisting of Cu, Al, Ga, Co, Zr, Ti, Nb and Mn;

B: 0.90-1.2 wt. %;

Fe: 61.4-69.5 wt. %;

(2) in the process of pulverization, O≤60 ppm in the pulverization atmosphere;

(3) in the pressing process, O≤40 ppm in the pressing atmosphere;

(4) the dispersant comprises element C, and the mass percentage of the dispersant in the mixed powder is 0.04-0.2%.

In the present invention, the content of R′ is preferably 29.5-33.3 wt. %, more preferably 9.5 wt. %, 30.5 wt. %, 30.8 wt. %, 31 wt. %, 31.5 wt. %, 32 wt. %, 32.3 wt. %, 32.8 wt. % or 33.3 wt. %, the percentage refers to the mass percentage in the raw material composition of the RTB-based permanent magnet material.

In the present invention, the content of Pr is preferably 8.85-27.15 wt. %, such as 8.85 wt. %, 9.85 wt. %, 10.15 wt. %, 10.85 wt. %, 11.85 wt. %, 12.15 wt. %, 13.15 wt. %, 14.15 wt. %, 16.15 wt. %, 17.15 wt. %, 18.15 wt. %, 19.15 wt. %, 20.15 wt,%, 21.15 wt. %, 22.15 wt. %, 23.15 wt. %, 24.15 wt. %, 25.15 wt. % or 27.15 wt. %, the percentage refers to the mass percentage in the raw material composition of the RTB-based permanent magnet material.

In the present invention, R′ can further comprise Nd and/or R, R is a rare earth element besides Pr and Nd.

Wherein, the content of Nd is preferably 3.35-22.65 wt. %, more preferably 3.35 wt. %, 5.35 wt. %, 6.65 wt. %, 6.85 wt. %, 7.35 wt. %, 7.85 wt. %, 8.35 wt,%, 8.65.%, 8.85 wt. %, 9.35 wt. %, 10.65 wt. %, 10.85 wt. %, 11.35 wt. %, 11.65 wt. %, 11.85 wt. %, 12.35 wt. %, 12.65 wt. %, 13.35 wt. %, 13.65 wt. %, 13.85 wt. %, 14.35 wt. %, 14.65 wt. %, 14.8 wt.5%, 15.35 wt. %, 16.35 wt. %, 16.65 wt. %, 16.85 wt. %, 17.35 wt. %, 17.65 wt. %, 18.35 wt. %, 18.65 wt. %, 18.85 wt. %, 19.35 wt. %, 19.65 wt. %, 20.65 wt. %, 20.85 wt. %, 21.35 wt. %, 21.65 wt.°, 21.95 wt. %, 22.15 wt. % or 22.65 wt. %, the percentage refers to the mass percentage in the raw material composition of the RTB-based permanent magnet material.

Wherein, mass ratio of Nd to R′ is preferably <0.72; such as, 0.11, 0.18, 0.22, 0.23, 0.24, 0.25, 0.28, 0.29, 0.30, 0.31, 0.32, 0.35, 0.36, 0.37, 0.38, 0.39, 0.40, 0.41, 0.42, 0.44, 0.45, 0.46, 0.47, 0.48, 0.49, 0.52, 0.54, 0.55, 0.59, 0.60, 0.61, 0.63, 0.64, 0.67, 0.68, 0.70 or 0.72.

Wherein, the kind of R is preferably Y and/or Ce.

Wherein, the content of R is preferably 0-1 wt. %, for example 0.3 wt. %, the percentage refers to the mass percentage in the raw material composition of the RTB-based permanent magnet material.

In the present invention, R can further comprise a heavy rare earth element RH.

Wherein, the kind of RH can be Dy and/or Tb.

Wherein, the content of RE can be the conventional content in this field, preferably 1.2-2.5 wt. %, such as 1.2 wt. %, 1.5 wt. %, 2 wt. % or 2.5 wt. %, and the percentage refers to the mass percentage in the raw material composition of the RTB-based permanent magnet material.

Wherein, the mass ratio of RH to his preferably <0.253, for example 0.038-0.075, such as 0.038, 0,039, 0.046, 0.061 or 0.075.

When the RH comprises Tb, the content of Tb is preferably 1.2-2.0 wt. %, for example 1.2 wt. % or 2.0 wt. %, the percentage refers to the mass percentage in the raw material composition of the RTB-based permanent magnet material.

When the RH comprises Dy, the content of Dy is preferably 1.5-2.5 wt. %, such as 1.5 wt. %, 2.0 wt. % or 2.5 wt. %, the percentage refers to the mass percentage in the raw material composition of the STB-based permanent magnet material.

In the present invention, the content of B is preferably 0.95-1.1 wt. %, such as 0.95 wt. %, 096%, 0.98 wt. % or 1.01 wt. %, the percentage refers to the mass percentage in the rale material composition of the RTB-based permanent magnet material.

In the present invention, the content of Fe is preferably 61.5-69.5 wt. %, such as 61.79 wt. %, 61.89 wt. %, 62.44 wt. %, 62.89 wt. %, 63.24 wt. %, 63.84 wt. %, 63.87 wt. %, 63.94 wt. %, 64.99 wt. %, 66.19 wt. %, 66.29 wt. %, 66.47 wt. %, 66.52 wt. %, 66.55 wt. %, 66.61 wt. %, 66.69 wt. %, 66.75 wt. %, 66.85 wt./, 66.97 wt. %, 67.00 wt. %, 67.02 wt. %, 67,068 wt. %, 67.13 wt. %, 67.14 wt. %, 67.19 wt. %, 67.24 wt. %, 67.25 wt. %, 67.35 wt. %, 67.37 wt. %, 67.45 wt. %, 67.49 wt. %, 67.54 wt. %, 67.55 wt. %, 67.57 wt. %, 67.59 wt. %, 67.64 t,%, 67.65 wt. %, 67.69 wt. %, 67,718 wt. %, 67.75 wt. %, 67.85 wt. %, 67.95 wt. %, 67.96 wt. %, 67.97 wt. %, 68.008 wt. %, 68.12 wt. %, 68.55 wt. %, 68.62 wt. %, 69.02 wt. %, 69.1 wt. %, 69.22 wt. %, 69.27 wt. %, 69.32 wt. % or 69.45 wt. %, the percentage refers to the mass percentage in the raw material composition of the RIB-based permanent magnet material.

In the present invention, X cart be Cu, Al Ga Co, Zr, Ti or Nb, can also be “Cu and Al”, “Ga and Mn”, “Cu, Al and Ga”, “Cu, Al, Ga and Zr”, “Cu, Al, Ga and Co” or “Cu, Al, Ga, Zr and Co”.

In the present invention, the content of the X is preferably 045 wt. %, such as, 0.02 wt. %, 0.042 wt. %, 0.1 wt. %, 0.2 wt. %, 0.25 wt. %, 0.3 wt. %, 0.35 wt. %, 0.36 wt. %, 0.4 wt. %, 0.42 wt. %, 0,422 wt. %, 0.45 wt. %, 0.5 wt.°, 0.52 wt. %, 0.522 wt. %, 0.6 wt. %, 0.64 wt. %, 0.67 wt. %, 0.7 wt. %, 0.74 wt. %, 0.8 wt. %, 0.87 wt. %. 0.88 wt. %, 0.89 wt. %, 0.9 wt. %, 0.94 wt. %, 1.00 wt. %, 1.02 wt. %, 1.%, 1.19 wt. %, 1.27 wt. %, 1.3 wt. %, 1.4 wt. %, 1.5 wt. %, 1.56 wt. %, 1.72 wt. %, 1.9%, 2.5 wt. %, 3.8 wt. %, 3.85 wt. %, 3.95 wt. % or 4.2 wt. %, the percentage refers to the mass percentage in the raw material composition of the RIB-based permanent magnet material.

When X comprises Cu, the content of the Cu is preferably 0.2-0.5%, such as, 0.2 wt. %, 0.3 wt. %, 0.34 wt. %, 0.35 wt. %, 0.38 wt. %, 0.4 wt. %, 0.42 wt. %, 0.44 wt. %, 0.45 wt. % or 0.5 wt. %, the percentage refers to the mass percentage in the raw material composition of the RIB-based permanent magnet material.

When the X comprises Al the content of Al is preferably 0-0.8 wt. %, but not 0, such as 0.01-0.03 wt. % or 0.5-0.8 wt. %, and then 0.01 wt. %, 0.02 wt. %, 0.03 wt. %, 0.042 wt. %, 0.1 wt. %, 0.2 wt. %, 0.3 wt. %, 0.35 wt. %, 0.4 wt. %, 0.45 wt. %, 0.5 wt. %, 0.6 wt. %, 0.7 wt. % or 0.8 wt. % the percentage refers to the mass percentage in the raw material composition of the RTB-based permanent magnet material.

When the X comprises Ga the content of Ga is preferably 0.0-1.85 wt. %, but not 0, and more preferably 0.11.55 wt. %, such as, 0.1 wt. %, 0.15 wt. %, 0.2 wt. %, 0.25 wt. %, 0.3 wt. %, 0.4 wt. %, 0.42 wt. %, 0.5 wt. %, 0.9 wt. %, 1.′1 wt. % or 1.55 wt. %, the percentage refers to the mass percentage in the raw material composition of the RTB-based, permanent magnet material.

When the X comprises Co, the content of Co is preferably 0.0-3.0 wt. %, but not 0, and more preferably 0.5-2.5 wt. %, such as 0.5 wt. %, 1.0 wt. % or 2.5 wt. %, the percentage refers to the mass percentage in the raw material composition of the RTB-based permanent magnet material.

When the X comprises Zr, the content of Zr is preferably 0.25-0.35 wt. %, such as 0.25 wt. %, 0.30 wt. % or 0.35 wt. %, the percentage refers to the mass percentage in the raw material composition of the RIB-based permanent magnet material.

When the X comprises Nb, the content of Nb is preferably 0.25-0.35 wt. %, such as 0.25 wt. %, 0.30 wt. % or 0.35 wt. %, the percentage refers to the mass percentage in the raw material composition of the RTB-based permanent magnet material.

When the X comprises Mn, the content of Mn is preferably 0.0-0.03 wt. %, but not 0, such as 0.01 wt. %, the percentage refers to the mass percentage to the ratio material composition of the RIB-based permanent magnet material.

In the present invention, the RTB-based permanent magnet material can further comprise conventional added element M, for example, M is one or more selected from the group of Ni, Zn, Ag, In, fan, Bi, V, Cr, Hf, Ta and W.

Wherein, the kind of M is preferably Cr.

Wherein, the content of M is preferably 0-0.15 wt. %, but not 0, such as 0.05 wt. % or 0.12 wt. %, and the percentage refers to the mass percentage in the raw material composition of the RTB-based permanent magnet material.

In a preferred embodiment of the present invention, the raw material composition of the RTB-based permanent magnet material comprises the following components: W: 29.5-315 wt. %, Pr≥8.85 t %, 0.2-0.5 wt. %, B: 0.95-1.1 wt. %, Fe: 61.5-69.5 wt. %, the percentage refers to the mass percentage in the raw material composition of the RIB-based permanent magnet material.

In a preferred embodiment of the present invention, the raw material composition of the RTB-based permanent magnet material comprises the following components: R′: 29.5-33.5 wt. %, Pr≥8.85 wt. %, Al: 0-0.8 wt. %, but not 0, B: 0.95-1.1 wt. %, Fe: 61.5-69.5 wt. %, the percentage refers to the mass percentage in the raw material composition of RIB-based permanent magnet material.

In a preferred embodiment of the present invention, the raw material composition of the RTB-based permanent magnet material comprises the following components: R: 29.5-33.5 wt. %, Pr≥8.85 wt. %, Ga: 0.1-1.85 wt. %, B: 0.95-1.1 wt. %, Fe: 61.5-69.5 wt. %, the percentage refers to the mass percentage in the raw material composition of the RIB-based permanent magnet material,

In a preferred embodiment of the present invention, the raw material composition of the RTB-based permanent magnet material comprises the following components: R′: 29.5-33.5 wt. %, Pr≥8.85 wt. %, Co: 0.0-3.0 wt. %, hut not 0, B: 0.95-1.1 wt. %, Fe: 61.5-69.5 wt. %, the percentage refers to the mass percentage in the raw material composition of the RIB-based permanent magnet material.

In a preferred embodiment of the present invention, the raw material composition of the RTB-based permanent magnet material comprises the following components: W: 29.5-33.5 wt. %, Pr≥8.85 wt. %, Zr: 0.25-0.35 wt. %, B: 0.95-1.1 wt. %, Fe: 61.5-69.5 wt. %, the percentage refers to the mass percentage in the raw material composition of the RIB-based permanent magnet material.

In a preferred embodiment of the present invention, the raw material composition of the RIB-based permanent magnet material comprises the following components: R′: 29.5-33.5 wt. %, Pr≥8.85 wt. %, Nb: 0.25-0.35 wt. %, B: 0.95-1.1 wt. %, Fe: 61.5-69.5 wt. %, the percentage refers to the mass percentage in the raw material composition of the RIB-based permanent magnet material.

In a preferred embodiment of the present invention, the raw material composition of the RTB-based permanent magnet material comprises the following components: R′: 29.5-33.5 wt. %, Pr≥8.85 wt. %, Cu: 0.34-0.51 wt. %, Al: 0-0.8 wt. %, but not 0, B: 0.95-1.1 wt. %, Fe: 61.5-69.5 wt. %, the percentage refers to the mass percentage in the raw material composition of the RIB-based permanent magnet material.

In a preferred embodiment of the present invention, the raw material composition of the RTB-based permanent magnet material comprises the following components: R: 29.5-33.5 wt. %, Pr≥8.85 wt. %, Cu: 0.34-0.51 wt. %, Al: 0-0.8 cwt. %, but not 0, Ga: 0.1-0.5 wt. %, B: 0.95-1.1 wt. %, Fe: 61.5-69.5 wt. %, the percentage refers to the mass percentage in the raw material composition of the RIB-based permanent magnet material:

In a preferred embodiment of the present invention, the raw material composition of the RIB-based permanent magnet material comprises the following components: R′: 29.5-33.5 wt. %, Pr≥8.85 wt. %, Cu: 0.34-0.5 wt. %, Al: 0.3-0.8 wt. %, Ga: 0.1-0.4 wt. %, Zr: 0.25-0.30 wt. %. B: 0.95-1.1 wt. %, Fe: 61.5-69.5 wt. %, the percentage refers to the mass percentage in the raw material composition of the RIB-based permanent magnet material.

In the present invention, the molten liquid of the raw material composition of the RIB-based permanent magnet material can be obtained by conventional methods in this field, for example, melting in a vacuum induction melting furnace, The vacuum degree of the melting furnace can be 5×10⁻² Pa. The melting temperature can be 1500° C. or less.

In the present invention, the casting process can be the conventional casting process in this field, for example, cooling at a rate of 10²° C./s to 10⁴° C./s in an Ar atmosphere.

In the present invention, the process of hydrogen decrepitation can be the conventional hydrogen decrepitation process in this field, for example, being subjected to hydrogen absorption, dehydrogenation and cooling treatment.

Wherein, the hydrogen absorption can be carried out at the hydrogen pressure of 0.15 MPa.

Wherein, the dehydrogenation can be carried out under the condition of both vacuum-pumping and heating.

In the present invention, the process of pulverization can be the conventional pulverization process in this field, such as jet mill pulverization.

The pressure in the pulverization chamber of jet mill pulverization can be 0.38 MPa.

The time of the jet mill pulverization can be 3 hours.

In the present invention, preferably, during the pulverization process, the content of oxygen O in the pulverization atmosphere is 0-50 ppm, such as 0 ppm, 5 ppm, 10 ppm, 15 ppm, 20 ppm, 25 ppm, 30 ppm, 35 ppm, 40 ppm, 45 ppm or 50 ppm.

In the present invention, dispersant can be a dispersant routinely added in the preparation process of R-T-B-based, permanent magnet materials, generally a lubricant and/or an antioxidant. Generally speaking, the lubricant and antioxidant added in the preparation of R-T-B-based magnet materials contain C element.

Wherein, the lubricant can be zinc stearate.

In the present invention, the amount of the dispersant is preferably 0.04-0.14%, such as 0.04%, 0.05%, 0.06%, 0.07%. 0.08%, 0.09%, 0.1%, 0.11%, 0.12%, 0.13% or 0.14%, the percentage refers to the mass percentage with respect to the total mass of the mixed powder.

When the dispersant contains zinc stearate, the amount of zinc stearate can be 0.04-0.14%, such as 0.04%, 0.05%, 0.06%, 0.07%, 0.08%, 0.09%, 0.1%, 0.11%, 0.12%, 0.13% or 0.14%, the percentage refers to the mass percentage with respect to the total mass of the mixed powder.

In the present invention, preferably, the content of oxygen O in the pressing atmosphere is 10-30 ppm during the pressing process, such as 10 ppm, 12 PPM, 14 ppm 16 ppm, 18 ppm, 20 ppm, 22 ppm, 24 ppm, 26 ppm, 28 ppm or 30 ppm. [011.7] in the present invention, the forming process can be a conventional forming process in this field, such as magnetic field forming method or hot pressing and hot deformation method.

In the present invention, the sintering process can be the conventional sintering process in this field, for example, under the vacuum condition (for example, under the vacuum of 5×10⁻³ Pa), being subjected to preheating, sintering, cooling.

Wherein, the temperature of the preheating can be 300-600° C., The time of the preheating can be 1-2 h. Preferably, the preheating is preheating at 300° C. and 600° C. for 111 respectively.

Wherein, the temperature of the sintering can be the conventional sintering temperature in this field, such as 1040-1090° C., and then 1050° C.

Wherein, the time of the sintering can be the conventional sintering time in this field, such as 2h.

Wherein, the Ar can be introduced to make the air pressure reach 0.1 MPa before cooling.

In the present invention, preferably, the grain boundary diffusion treatment is also carried out after sintering and before the aging treatment.

Wherein, the grain boundary diffusion treatment can be treated according to the conventional process in this field, for example, attaching substance containing Tb and/or substance containing Dy to the surface of the RIB-based permanent magnet material by evaporating, coating or sputtering, then carrying out diffusion heat treatment.

The substance containing Tb may be Tb metal, a Tb-containing compound (for example, a Tb-containing fluoride) or an alloy.

The substance containing Dy may be Dy metal, a Dy-containing compound (for example, Dy-containing fluoride) or an alloy.

The temperature of the diffusion heat treatment is preferably 800-900° C., such as 850° C.

The time, of the diffusion heat treatment is preferably 12-48 h, such as 24h.

In the present invention, the treatment temperature of the aging treatment is 500-650° C. for example 600-650° C., such as 630° C.

Wherein, in the aging treatment, the heating rate of heating to 500-650° C. is preferably 3-5° C./min. The starting point for the heating can be morn temperature.

Wherein, the treatment time of the aging treatment is 3 h.

The present invention also provides an RTB-based permanent magnet material prepared by the above method.

The invention also provides an application of the R-T-B-based permanent magnet material as an electronic components.

Therein, the fields of the application can be automobile drive field, wind power field, servo motor and home appliance field (such as air conditioning).

In the present invention, the room temperature refers to 25″C+5° C.

In the present invention, Pr is praseodymium, Nd is neodymium, Cu is copper, B is boron, Fe is iron, Al is aluminum, Ga is gallium, Co is cobalt, Zr is zirconium, Tis titanium, Nb is niobium, Zn is zinc, Dy is dysprody, Tb is terbium, Mn is manganese, Ni is nickel, Ag is silver, In is indium, Sn is tin, Bi is bismuth, V is vanadium, Cr is chromium, Ta is tantalum, W is tungsten, O is oxygen, C is carbon, and N is nitrogen.

On the basis of conforming to the common knowledge in this field, the above optimal conditions can be combined at will, so as to obtain better examples of the present invention.

The reagents and raw materials used in the present invention are commercially available.

The positive progressive effect of the present invention is as follows:

(1) The RTB-based permanent magnet material in the present invention can achieve the improvement of the performance of permanent magnet materials in the absence of heavy rare earth, and the RTB-based permanent magnet material has excellent magnetic properties, high coercivity, high remanence and good temperature stability.

(2) The preparation process of RTB-based permanent magnet material does not need to control the content of carbon elements introduced in the process, and under the condition of higher carbon content in the magnet, the magnet still maintains excellent performance.

### BRIEF DESCRIPTION OF THE DRAWINGS

FIG. 1 is the microstructure scanning photo of the RTB-based permanent magnet mater prepared in embodiment 68, wherein, the position referred to by a is the intergranular triangle region.

### DETAILED DESCRIPTION OF THE PREFERRED EMBODIMENT

The following examples further illustrate the present disclosure, but the present disclosure is not limited thereto. Experimental methods for which specific conditions are not specified in the following embodiments shall be selected in accordance with conventional methods and conditions, or in accordance with the commodity description. In the following table, wt. % refers to the percentage by mass of the component in the raw material composition of the RTB-based permanent magnet material, and “/” means that the element is not added. “Br” refers to remanence, and “Hcj” refers to intrinsic coercivity.

The formulas of RTB-based permanent magnet materials of the embodiments and comparative embodiments are shown in Table 1.

TABLE 1

| | | R | Nd | Pr | | RH | Cu | | Ga | Co | Zr | Nb | Mn | | M | B | |
|---|---|---|---|---|---|---|---|---|---|---|---|---|---|---|---|---|---|
| | R | con- | wt. | wt. | RH | wt. | wt. | Al | wt. | wt. | wt. | wt. | wt. | M | wt. | wt. | Fe |
| No. | kind | tent | % | % | kind | % | % | wt. % | % | % | % | % | % | kind | % | % | wt. % |
| Embodi- | / | / | 21.65 | 8.85 | / | / | / | / | / | / | / | / | / | / | / | 0.95 | remainder |
| ment 1 | | | | | | | | | | | | | | | | | |
| Embodi- | / | / | 19.65 | 10.85 | / | / | / | / | / | / | / | / | / | / | / | 0.95 | remainder |
| ment 2 | | | | | | | | | | | | | | | | | |
| Embodi- | / | / | 18.35 | 12.15 | / | / | / | / | / | / | / | / | / | / | / | 0.95 | remainder |
| ment 3 | | | | | | | | | | | | | | | | | |
| Embodi- | / | / | 16.35 | 14.15 | / | / | / | / | / | / | / | / | / | / | / | 0.95 | remainder |
| ment 4 | | | | | | | | | | | | | | | | | |
| Embodi- | / | / | 14.35 | 16.15 | / | / | / | / | / | / | / | / | / | / | / | 0.95 | remainder |
| ment 5 | | | | | | | | | | | | | | | | | |
| Embodi- | / | / | 13.35 | 17.15 | / | / | / | / | / | / | / | / | / | / | / | 0.95 | remainder |
| ment 6 | | | | | | | | | | | | | | | | | |
| Embodi- | / | / | 11.35 | 19.15 | / | / | / | / | / | / | / | / | / | / | / | 0.95 | remainder |
| ment 7 | | | | | | | | | | | | | | | | | |
| Embodi- | / | / | 9.35 | 21.15 | / | / | / | / | / | / | / | / | / | / | / | 0.95 | remainder |
| ment 8 | | | | | | | | | | | | | | | | | |
| Embodi- | / | / | 7.35 | 23.15 | / | / | / | / | / | / | / | / | / | / | / | 0.95 | remainder |
| ment 9 | | | | | | | | | | | | | | | | | |
| Embodi- | / | / | 5.35 | 25.15 | / | / | / | / | / | / | / | / | / | / | / | 0.95 | remainder |
| ment 10 | | | | | | | | | | | | | | | | | |
| Embodi- | / | / | 3.35 | 27.15 | / | / | / | / | / | / | / | / | / | / | / | 0.95 | remainder |
| ment 11 | | | | | | | | | | | | | | | | | |
| Embodi- | / | / | 22.15 | 8.85 | / | / | 0.20 | / | / | / | / | / | / | / | / | 0.95 | remainder |
| ment 12 | | | | | | | | | | | | | | | | | |
| Embodi- | / | / | 18.85 | 12.15 | / | / | 0.30 | / | / | / | / | / | / | / | / | 1.01 | remainder |
| ment 13 | | | | | | | | | | | | | | | | | |
| Embodi- | / | / | 13.85 | 17.15 | / | / | 0.35 | / | / | / | / | / | / | / | / | 1.01 | remainder |
| ment 14 | | | | | | | | | | | | | | | | | |
| Embodi- | / | / | 10.85 | 20.15 | / | / | 0.45 | / | / | / | / | / | / | / | / | 1.01 | remainder |
| ment 15 | | | | | | | | | | | | | | | | | |
| Embodi- | / | / | 7.85 | 23.15 | / | / | 0.50 | / | / | / | / | / | / | / | / | 1.01 | remainder |
| ment 16 | | | | | | | | | | | | | | | | | |
| Embodi- | / | / | 22.15 | 8.85 | / | / | / | 0.02 | / | / | / | / | / | / | / | 1.01 | remainder |
| ment 17 | | | | | | | | | | | | | | | | | |
| Embodi- | / | / | 20.85 | 10.15 | / | / | / | 0.042 | / | / | / | / | / | / | / | 0.95 | remainder |
| ment 18 | | | | | | | | | | | | | | | | | |
| Embodi- | / | / | 18.85 | 12.15 | / | / | / | 0.1 | / | / | / | / | / | / | / | 0.95 | remainder |
| ment 19 | | | | | | | | | | | | | | | | | |
| Embodi- | / | / | 16.85 | 14.15 | / | / | / | 0.2 | / | / | / | / | / | / | / | 0.95 | remainder |
| ment 20 | | | | | | | | | | | | | | | | | |
| Embodi- | / | / | 14.85 | 16.15 | / | / | / | 0.3 | / | / | / | / | / | / | / | 0.95 | remainder |
| ment 21 | | | | | | | | | | | | | | | | | |
| Embodi- | / | / | 13.85 | 17.15 | / | / | / | 0.4 | / | / | / | / | / | / | / | 0.95 | remainder |
| ment 22 | | | | | | | | | | | | | | | | | |
| Embodi- | / | / | 11.85 | 19.15 | / | / | / | 0.5 | / | / | / | / | / | / | / | 0.95 | remainder |
| ment 23 | | | | | | | | | | | | | | | | | |
| Embodi- | / | / | 10.85 | 20.15 | / | / | / | 0.6 | / | / | / | / | / | / | / | 0.95 | remainder |
| ment 24 | | | | | | | | | | | | | | | | | |
| Embodi- | / | / | 8.85 | 12.15 | / | / | / | 0.7 | / | / | / | / | / | / | / | 0.95 | remainder |
| ment 25 | | | | | | | | | | | | | | | | | |
| Embodi- | / | / | 6.85 | 24.15 | / | / | / | 0.8 | / | / | / | / | / | / | / | 0.95 | remainder |
| ment 26 | | | | | | | | | | | | | | | | | |
| Embodi- | / | / | 20.65 | 8.85 | / | / | / | / | 0.1 | / | / | / | / | / | / | 0.95 | remainder |
| ment 27 | | | | | | | | | | | | | | | | | |
| Embodi- | / | / | 19.68 | 9.85 | / | / | / | / | 0.2 | / | / | / | / | / | / | 0.98 | remainder |
| ment 28 | | | | | | | | | | | | | | | | | |
| Embodi- | / | / | 18.65 | 10.85 | / | / | / | / | 0.25 | / | / | / | / | / | / | 0.98 | remainder |
| ment 29 | | | | | | | | | | | | | | | | | |
| Embodi- | / | / | 17.65 | 11.85 | / | / | / | / | 0.30 | / | / | / | / | / | / | 0.98 | remainder |
| ment 30 | | | | | | | | | | | | | | | | | |
| Embodi- | / | / | 17.35 | 12.15 | / | / | / | / | 0.42 | / | / | / | / | / | / | 0.98 | remainder |
| ment 31 | | | | | | | | | | | | | | | | | |
| Embodi- | / | / | 16.35 | 13.15 | / | / | / | / | 0.50 | / | / | / | / | / | / | 0.98 | remainder |
| ment 32 | | | | | | | | | | | | | | | | | |
| Embodi- | / | / | 15.35 | 14.15 | / | / | / | / | 0.90 | / | / | / | / | / | / | 0.98 | remainder |
| ment 33 | | | | | | | | | | | | | | | | | |
| Embodi- | / | / | 9.35 | 20.15 | / | / | / | / | 1.40 | / | / | / | / | / | / | 0.98 | remainder |
| ment 34 | | | | | | | | | | | | | | | | | |
| Embodi- | / | / | 8.35 | 21.15 | / | / | / | / | 1.55 | / | / | / | 0.01 | / | / | 0.98 | remainder |
| ment 35 | | | | | | | | | | | | | | | | | |
| Embodi- | / | / | 14.35 | 175 | / | / | / | / | / | 0.5 | / | / | / | / | / | 0.98 | remainder |
| ment 36 | | | | | | | | | | | | | | | | | |
| Embodi- | / | / | 13.35 | 18.15 | / | / | / | / | / | 1 | / | / | / | / | / | 0.98 | remainder |
| ment 37 | | | | | | | | | | | | | | | | | |
| Embodi- | / | / | 12.35 | 19.15 | / | / | / | / | / | 2.5 | / | / | / | / | / | 1.01 | remainder |
| ment 38 | | | | | | | | | | | | | | | | | |
| Embodi- | / | / | 14.35 | 17.15 | / | / | / | / | / | / | 0.25 | / | / | / | / | 1.01 | remainder |
| ment 39 | | | | | | | | | | | | | | | | | |
| Embodi- | / | / | 13.35 | 18.15 | / | / | / | / | / | / | 0.30 | / | / | / | / | 1.01 | remainder |
| ment 40 | | | | | | | | | | | | | | | | | |
| Embodi- | / | / | 12.35 | 19.15 | / | / | / | / | / | / | 0.35 | / | / | / | / | 1.01 | remainder |
| ment 41 | | | | | | | | | | | | | | | | | |
| Embodi- | / | / | 14.35 | 17.15 | / | / | / | / | / | / | / | 0.25 | / | / | / | 1.01 | remainder |
| ment 42 | | | | | | | | | | | | | | | | | |
| Embodi- | / | / | 13.35 | 18.15 | / | / | / | / | / | / | / | 0.30 | / | / | / | 1.01 | remainder |
| ment 43 | | | | | | | | | | | | | | | | | |
| Embodi- | / | / | 12.35 | 19.15 | / | / | / | / | / | / | / | 0.35 | / | / | / | 1.01 | remainder |
| ment 44 | | | | | | | | | | | | | | | | | |
| Embodi- | / | / | 22.65 | 8.85 | / | / | 0.34 | 0.02 | / | / | / | / | / | / | / | 1.01 | remainder |
| ment 45 | | | | | | | | | | | | | | | | | |
| Embodi- | / | / | 21.35 | 10.15 | / | / | 0.38 | 0.042 | / | / | / | / | / | / | / | 1.01 | remainder |
| ment 46 | | | | | | | | | | | | | | | | | |
| Embodi- | / | / | 19.35 | 12.15 | / | / | 0.42 | 0.1 | / | / | / | / | / | / | / | 1.01 | remainder |
| ment 47 | | | | | | | | | | | | | | | | | |
| Embodi- | / | / | 17.35 | 14.15 | / | / | 0.44 | 0.2 | / | / | / | / | / | / | / | 1.01 | remainder |
| ment 48 | | | | | | | | | | | | | | | | | |
| Embodi- | / | / | 15.35 | 16.15 | / | / | 0.50 | 0.3 | / | / | / | / | / | / | / | 1.01 | remainder |
| ment 49 | | | | | | | | | | | | | | | | | |
| Embodi- | / | / | 14.35 | 17.15 | / | / | 0.34 | 0.4 | / | / | / | / | / | / | / | 1.01 | remainder |
| ment 50 | | | | | | | | | | | | | | | | | |
| Embodi- | / | / | 12.35 | 19.15 | / | / | 0.35 | 0.5 | / | / | / | / | / | / | / | 1.01 | remainder |
| ment 51 | | | | | | | | | | | | | | | | | |
| Embodi- | / | / | 11.35 | 20.15 | / | / | 0.42 | 0.6 | / | / | / | / | / | / | / | 1.01 | remainder |
| ment 52 | | | | | | | | | | | | | | | | | |
| Embodi- | / | / | 9.35 | 22.15 | / | / | 0.34 | 0.5 | 0.1 | / | / | / | / | / | / | 1.01 | remainder |
| ment 53 | | | | | | | | | | | | | | | | | |
| Embodi- | / | / | 7.35 | 24.15 | / | / | 0.40 | 0.6 | 0.3 | / | / | / | / | / | / | 1.01 | remainder |
| ment 54 | | | | | | | | | | | | | | | | | |
| Embodi- | / | / | 13.65 | 17.15 | / | / | 0.50 | 0.8 | 0.42 | / | / | / | / | / | / | 1.01 | remainder |
| ment 55 | | | | | | | | | | | | | | | | | |
| Embodi- | / | / | 8.65 | 22.15 | / | / | 0.34 | 0.5 | 0.1 | / | 0.25 | / | / | / | / | 1.01 | remainder |
| ment 56 | | | | | | | | | | | | | | | | | |
| Embodi- | / | / | 6.65 | 24.15 | / | / | 0.50 | 0.8 | 0.3 | / | 0.30 | / | / | / | / | 1.01 | remainder |
| ment 57 | | | | | | | | | | | | | | | | | |
| Embodi- | / | / | 21.98 | 8.85 | / | / | 0.34 | 0.01 | 0.25 | / | / | / | / | / | / | 1.01 | remainder |
| ment 58 | | | | | | | | | | | | | | | | | |
| Embodi- | / | / | 20.65 | 10.15 | / | / | 0.38 | 0.02 | 0.30 | / | / | / | / | / | / | 0.96 | Remainder |
| ment 59 | | | | | | | | | | | | | | | | | |
| Embodi- | / | / | 18.65 | 12.15 | / | / | 0.42 | 0.03 | 0.42 | / | / | / | / | / | / | 0.96 | remainder |
| ment 60 | | | | | | | | | | | | | | | | | |
| Embodi- | / | / | 16.65 | 14.15 | / | / | 0.38 | 0.042 | 0.1 | / | / | / | / | / | / | 0.96 | remainder |
| ment 61 | | | | | | | | | | | | | | | | | |
| Embodi- | / | / | 14.65 | 16.15 | / | / | 0.42 | 0.1 | 0.15 | / | / | / | / | / | / | 0.96 | remainder |
| ment 62 | | | | | | | | | | | | | | | | | |
| Embodi- | / | / | 13.65 | 17.15 | / | / | 0.44 | 0.2 | 0.25 | / | / | / | / | / | / | 0.96 | remainder |
| ment 63 | | | | | | | | | | | | | | | | | |
| Embodi- | / | / | 11.65 | 19.15 | / | / | 0.50 | 0.3 | 0.30 | / | / | / | / | / | / | 0.96 | remainder |
| ment 64 | | | | | | | | | | | | | | | | | |
| Embodi- | / | / | 10.65 | 20.15 | / | / | 0.45 | 0.4 | 0.42 | / | / | / | / | / | / | 0.96 | remainder |
| ment 65 | | | | | | | | | | | | | | | | | |
| Embodi- | / | / | 8.65 | 22.15 | / | / | 0.50 | 0.5 | 0.50 | / | / | / | / | / | / | 1.01 | remainder |
| ment 66 | | | | | | | | | | | | | | | | | |
| Embodi- | / | / | 12.65 | 18.15 | / | / | 0.4 | 0.6 | 0.4 | 2.5 | 0.3 | / | / | Cr | 0.05 | 1.01 | remainder |
| ment 67 | | | | | | | | | | | | | | | | | |
| Embodi- | / | / | 12.65 | 18.15 | / | / | 0.4 | 0.6 | 0.4 | 2.5 | 0.3 | / | / | Cr | 0.12 | 1.01 | remainder |
| ment 68 | | | | | | | | | | | | | | | | | |
| Embodi- | / | / | 13.65 | 17.15 | Dy | 1.5 | 0.4 | 0.3 | 0.30 | 2.5 | 0.3 | / | / | / | / | 1.01 | remainder |
| ment 69 | | | | | | | | | | | | | | | | | |
| Embodi- | / | / | 12.65 | 18.15 | Dy | 2.0 | 0.4 | 0.3 | 0.30 | 2.5 | 0.3 | / | / | / | / | 0.96 | remainder |
| ment 70 | | | | | | | | | | | | | | | | | |
| Embodi- | / | / | 11.65 | 19.15 | Dy | 2.5 | 0.4 | 0.35 | 0.30 | 2.5 | 0.3 | / | / | / | / | 0.96 | remainder |
| ment 71 | | | | | | | | | | | | | | | | | |
| Embodi- | / | / | 11.65 | 19.15 | Dy | 2.5 | 0.4 | 0.45 | 0.30 | 2.5 | 0.3 | / | / | / | / | 0.96 | remainder |
| ment 72 | | | | | | | | | | | | | | | | | |
| Embodi- | / | / | 13.65 | 17.15 | Tb | 2 | 0.4 | 0.3 | 0.30 | 2.5 | 0.3 | / | / | / | / | 0.96 | remainder |
| ment 73 | | | | | | | | | | | | | | | | | |
| Embodi- | / | / | 12.65 | 18.15 | Tb | 1.2 | 0.4 | 0.3 | 0.30 | 2.5 | 0.3 | / | / | / | / | 0.96 | remainder |
| ment 74 | | | | | | | | | | | | | | | | | |
| Embodi- | Ce | 0.3 | 11.35 | 18.15 | Tb | 1.2 | 0.4 | 0.6 | 0.4 | 2.5 | 0.3 | / | / | / | / | 0.96 | remailider |
| ment 75 | | | | | | | | | | | | | | | | | |
| Compar- | / | / | 22 | 8.00 | / | / | / | / | / | / | / | / | / | / | / | 0.96 | remainder |
| ative | | | | | | | | | | | | | | | | | |
| Embodi- | | | | | | | | | | | | | | | | | |
| ment 1 | | | | | | | | | | | | | | | | | |
| Compar- | / | / | 22 | 8.00 | / | / | 0.4 | 0 | 0.4 | 2.5 | 0.3 | / | / | Cr | 0.12 | 0.96 | remainder |
| ative | | | | | | | | | | | | | | | | | |
| Embodi- | | | | | | | | | | | | | | | | | |
| ment 2 | | | | | | | | | | | | | | | | | |

### EMBODIMENT

The preparation method for the RTB-based permanent magnet material is as follows:

(1) Melting process: according to the formula shown in Table 1, the pre-made raw materials were put into the crucible made of aluminum oxide, and vas vacuum melted in the high frequency vacuum induction melting furnace and in a vacuum of 5×10⁻² Pa at a temperature of 1500° C. or less.

(2) Casting process: Ar gas was introduced into the melting furnace after vacuum melting to make the air pressure reach 55,000 Pa, and then casting was carried out, and quenching alloy was obtained at the cooling rate of 10²° C./s to 10⁴° C./s.

(3) Hydrogen decrepitation process: the hydrogen decrepitation furnace with quench alloy placed therein was vacuumed at room temperature, and then hydrogen with a purity of 99.9% was introduced into the hydrogen decrepitation furnace to maintain the hydrogen pressure at 0.15 MPa; after fill hydrogen absorption, the temperature was raised while vacuuming for Mil dehydrogenation; then cooled, and took out the powder obtained from hydrogen decrepitation.

(4) Micro-pulverization process: In nitrogen atmosphere and under the condition of a pressure of 0.38 MPa in the pulverization chamber, the powder obtained from hydrogen decrepitation was pulverized by jet mill pulverization for 3 hours to obtain fine powder. The content of oxygen (ppm) in nitrogen atmosphere is shown in Table 2.

(5) The zinc stearate was added to the powder obtained from jet mill pulverization, and mixed fully by v-type mixer. The added amount of zinc stearate is shown in Table 2, and the percentage refers to the weight percentage in the mixed powder.

(6) Magnetic field forming process: The rectangular oriented magnetic field forming machine was used to form the above powder with zinc stearate into a cube with sides of 25 mm in a oriented magnetic field of 1.6 T and under the molding pressure of 0.35ton/cm²; demagnetization was carried out in a magnetic field of 0.2 T after forming. The content of O (oxygen) in the atmosphere during the pressing process was shown in Table 2 In order to prevent the formed body after the first forming from contacting the air, it was sealed, and then the secondary forming was carried out with the secondary forming machine (isostatic pressing machine) under the pressure of 1.3 ton/cm².

(7) Sintering process: each formed body was moved to the sintering furnace for sintering, sintered in the vacuum of 5×10⁻³ Pa and at 300° C. and 600° C. for 1 hour respectively; then, it was sintered at the temperature of 1050° C. for 2 hours; Ar was then introduced to make the air pressure reach 0.1 MPa and then cooled to room temperature.

(8) Aging treatment process: The sintered body was heated from 20° C. to 630° C. at a heating rate of 3-5° C./min in the Ar of high purity; after 3 hours of heat treatment at 630° C., it was cooled to room temperature and taken out.

### Embodiments 2-75, Comparative Embodiments 1-2

The formulas of Embodiments 2-75, comparative embodiments 1-2 are shown in Table 1, the preparation process is shown in Table 2, and the remaining steps are the same as those in Embodiment 1.

### Embodiment 76

The sintered body obtained in Embodiment 1 was first subjected to grain boundary diffusion treatment and then to aging treatment. The preparation process is shown in Table 2, and the other steps are the same as those in Embodiment 1. The process of grain boundary diffusion treatment is as follows:

The sintered body was processed into the magnet with diameter of 20 mm, and the thickness of the sheet material was less than 7 mm, the direction of the thickness was the direction of magnetic field orientation, after the surface was cleaned, the raw material prepared with Dy fluoride was coated on the magnet through fully spraying respectively, after drying the coated magnet, the metal attached with Dy was sputtered on the surface of the magnet in the high purity Ar atmosphere, and diffusing heat treatment was carried out at 850° C. for 24 hours. Cooled to room temperature.

### Embodiment 77

The sintered body obtained in Embodiment 1 was first subjected to grain boundary diffusion treatment and then to aging treatment. The preparation process is shown in Table 2, and the other steps are the same as those in Embodiment 1. The process of rain boundary diffusion treatment is as follows:

The sintered body was processed into the magnet with diameter of 20 mm, and the thickness of the sheet material was less than 7 mm, the direction of the thickness was the direction of magnetic field orientation, after the surface was cleaned, the raw material prepared with Tb fluoride was coated on the magnet through fully spraying respectively, after drying the coated magnet, the metal attached with Tb was sputtered on the surface of the magnet in the high purity Ar atmosphere, and diffusing heat treatment was carried out at 850° C. for 24 hours, Cooled to room temperature.

TABLE 2

| | Content of O | Amount of | Content of O | Grain | Elements in |
|---|---|---|---|---|---|
| | (ppm) in the | zinc stearate | (ppm) in the | boundary | grain |
| | milling process | (%) added in | pressing process | diffusion | boundary |
| No. | of step 4 | Step 5 | of step 6 | (Y/N) | diffusion |
| Embodiment 1 | 0 | 0.04 | 10 | N | / |
| Embodiment 2 | 5 | 0.05 | 12 | N | / |
| Embodiment 3 | 10 | 0.06 | 14 | N | / |
| Embodiment 4 | 15 | 0.07 | 16 | N | / |
| Embodiment 5 | 20 | 0.08 | 18 | N | / |
| Embodiment 6 | 25 | 0.09 | 20 | N | / |
| Embodiment 7 | 30 | 0.10 | 22 | N | / |
| Embodiment 8 | 35 | 0.11 | 24 | N | / |
| Embodiment 9 | 40 | 0.12 | 26 | N | / |
| Embodiment 10 | 45 | 0.13 | 28 | N | / |
| Embodiment 11 | 50 | 0.14 | 30 | N | / |
| Embodiment 12 | 0 | 0.04 | 10 | N | / |
| Embodiment 13 | 5 | 0.05 | 12 | N | / |
| Embodiment 14 | 10 | 0.06 | 14 | N | / |
| Embodiment 15 | 15 | 0.07 | 16 | N | / |
| Embodiment 16 | 20 | 0.08 | 18 | N | / |
| Embodiment 17 | 25 | 0.09 | 20 | N | / |
| Embodiment 18 | 30 | 0.10 | 22 | N | / |
| Embodiment 19 | 35 | 0.11 | 24 | N | / |
| Embodiment 20 | 40 | 0.12 | 26 | N | / |
| Embodiment 21 | 45 | 0.13 | 28 | N | / |
| Embodiment 22 | 50 | 0.14 | 30 | N | / |
| Embodiment 23 | 15 | 0.07 | 16 | N | / |
| Embodiment 24 | 20 | 0.08 | 18 | N | / |
| Embodiment 25 | 15 | 0.07 | 16 | N | / |
| Embodiment 26 | 20 | 0.08 | 18 | N | / |
| Embodiment 27 | 0 | 0.04 | 10 | N | / |
| Embodiment 28 | 5 | 0.05 | 12 | N | / |
| Embodiment 29 | 10 | 0.06 | 14 | N | / |
| Embodiment 30 | 15 | 0.07 | 16 | N | / |
| Embodiment 31 | 20 | 0.08 | 18 | N | / |
| Embodiment 32 | 25 | 0.09 | 20 | N | / |
| Embodiment 33 | 30 | 0.10 | 22 | N | / |
| Embodiment 34 | 35 | 0.11 | 24 | N | / |
| Embodiment 35 | 40 | 0.12 | 26 | N | / |
| Embodiment 36 | 0 | 0.04 | 10 | N | / |
| Embodiment 37 | 5 | 0.05 | 12 | N | / |
| Embodiment 38 | 10 | 0.06 | 14 | N | / |
| Embodiment 39 | 15 | 0.07 | 16 | N | / |
| Embodiment 40 | 20 | 0.08 | 18 | N | / |
| Embodiment 41 | 25 | 0.09 | 20 | N | / |
| Embodiment 42 | 30 | 0.10 | 22 | N | / |
| Embodiment 43 | 35 | 0.11 | 24 | N | / |
| Embodiment 44 | 40 | 0.12 | 26 | N | / |
| Embodiment 45 | 45 | 0.13 | 28 | N | / |
| Embodiment 46 | 50 | 0.14 | 30 | N | / |
| Embodiment 47 | 15 | 0.07 | 16 | N | / |
| Embodiment 48 | 20 | 0.08 | 18 | N | / |
| Embodiment 49 | 15 | 0.07 | 16 | N | / |
| Embodiment 50 | 20 | 0.08 | 18 | N | / |
| Embodiment 51 | 15 | 0.07 | 16 | N | / |
| Embodiment 52 | 20 | 0.08 | 18 | N | / |
| Embodiment 53 | 15 | 0.07 | 16 | N | / |
| Embodiment 54 | 20 | 0.08 | 18 | N | / |
| Embodiment 55 | 0 | 0.04 | 10 | N | / |
| Embodiment 56 | 5 | 0.05 | 12 | N | / |
| Embodiment 57 | 10 | 0.06 | 14 | N | / |
| Embodiment 58 | 15 | 0.07 | 16 | N | / |
| Embodiment 59 | 20 | 0.08 | 18 | | |
| Embodiment 60 | 25 | 0.09 | 20 | | |
| Embodiment 61 | 30 | 0.10 | 22 | N | / |
| Embodiment 62 | 35 | 0.11 | 24 | N | / |
| Embodiment 63 | 40 | 0.12 | 26 | N | / |
| Embodiment 64 | 45 | 0.13 | 28 | N | / |
| Embodiment 65 | 50 | 0.14 | 30 | N | / |
| Embodiment 66 | 15 | 0.07 | 16 | N | / |
| Embodiment 67 | 0 | 0.04 | 10 | N | / |
| Embodiment 68 | 5 | 0.05 | 12 | N | / |
| Embodiment 69 | 10 | 0.06 | 14 | N | / |
| Embodiment 70 | 15 | 0.07 | 16 | N | / |
| Embodiment 71 | 20 | 0.08 | 18 | N | / |
| Embodiment 72 | 25 | 0.09 | 20 | N | / |
| Embodiment 73 | 30 | 0.10 | 22 | N | / |
| Embodiment 74 | 35 | 0.11 | 24 | N | / |
| Embodiment 75 | 40 | 0.12 | 26 | N | / |
| Embodiment 76 | 0 | 0.04 | 10 | Y | Dy |
| Embodiment 77 | 0 | 0.04 | 10 | Y | Tb |
| Comparative | 20 | 0.08 | 18 | N | / |
| Embodiment 1 | | | | | |
| Comparative | 20 | 0.08 | 18 | N | / |
| Embodiment 2 | | | | | |

Note:
The percentage of zinc stearate added refers to the weight percentage in the mixed powder, and the content of O (oxygen) refers to the content of O (oxygen) atom in the atmosphere.

### Effect Embodiment

The magnetic properties and composition of RTB-based permanent magnet materials prepared in Embodiments 1-77 and Comparative embodiments 1-2 were determined, and the crystal phase structure of the magnets was observed by Fe-EPMA.

(1) Evaluation of magnetic properties: The NIM-10000H BR bulk rare earth permanent magnetic nondestructive measurement system in National Institute of Metrology, China was used for magnetic properties detection of permanent magnetic materials. The test results of magnetic properties are shown in Table 3 below,

TABLE 3

| | | | Absolute value | Absolute value | Absolute value |
|---|---|---|---|---|---|
| | | | of Hcj | of Hcj | of Hcj |
| | | | temperature | temperature | temperature |
| | | | coefficient at | coefficient at | coefficient at |
| No. | Br(kGs) | Hcj(kOe) | 80° C. | 150° C. | 180° C. |
| Embodiment 1 | 14.5 | 16.37 | 0.748 | / | / |
| Embodiment 2 | 14.51 | 16.9 | 0.735 | / | / |
| Embodiment 3 | 14.48 | 17.23 | 0.701 | / | / |
| Embodiment 4 | 14.42 | 17.75 | 0.662 | / | / |
| Embodiment 5 | 14.37 | 18.26 | 0.647 | / | / |
| Embodiment 6 | 14.35 | 18.51 | 0.653 | / | / |
| Embodiment 7 | 14.30 | 19.03 | 0.648 | / | / |
| Embodiment 8 | 14.25 | 19.54 | 0.642 | / | / |
| Embodiment 9 | 14.2 | 20.05 | 0.637 | / | / |
| Embodiment 10 | 14.15 | 20.56 | 0.631 | / | / |
| Embodiment 11 | 14.11 | 21.08 | 0.626 | / | / |
| Embodiment 12 | 14.34 | 17.06 | 0.715 | / | / |
| Embodiment 13 | 14.16 | 18.14 | 0.652 | / | / |
| Embodiment 14 | 14.03 | 19.54 | 0.641 | / | / |
| Embodiment 15 | 13.91 | 20.55 | 0.632 | / | / |
| Embodiment 16 | 13.82 | 21.32 | 0.622 | / | / |
| Embodiment 17 | 14.32 | 16.68 | 0.731 | / | / |
| Embodiment 18 | 14.27 | 17.12 | 0.715 | / | / |
| Embodiment 19 | 14.17 | 17.92 | 0.668 | / | / |
| Embodiment 20 | 14.02 | 18.93 | 0.648 | / | / |
| Embodiment 21 | 13.88 | 19.94 | 0.639 | / | / |
| Embodiment 22 | 13.76 | 20.7 | 0.637 | / | / |
| Embodiment 23 | 13.62 | 21.71 | 0.618 | / | / |
| Embodiment 24 | 13.5 | 22.46 | 0.605 | / | / |
| Embodiment 25 | 13.36 | 23.47 | 0.597 | / | / |
| Embodiment 26 | 13.22 | 24.48 | / | / | / |
| Embodiment 27 | 14.68 | 16.58 | 0.734 | 0.524 | / |
| Embodiment 28 | 14.65 | 17.51 | 0.668 | / | / |
| Embodiment 29 | 14.61 | 18.11 | 0.653 | / | / |
| Embodiment 30 | 14.55 | 18.70 | 0.651 | / | / |
| Embodiment 31 | 14.43 | 19.59 | 0.641 | / | / |
| Embodiment 32 | 14.38 | 20.39 | 0.636 | / | / |
| Embodiment 33 | 14.3 | 22.85 | 0.601 | 0.526 | / |
| Embodiment 34 | 13.95 | 24.39 | / | 0.522 | / |
| Embodiment 35 | 13.93 | 24.42 | / | / | / |
| Embodiment 36 | 14.02 | 18.43 | 0.668 | / | / |
| Embodiment 37 | 14.39 | 18.69 | 0.654 | / | / |
| Embodiment 38 | 13.72 | 19.45 | 0.648 | / | / |
| Embodiment 39 | 13.85 | 18.61 | 0.657 | / | / |
| Embodiment 40 | 13.81 | 18.81 | 0.653 | / | / |
| Embodiment 41 | 13.76 | 19.19 | 0.649 | / | / |
| Embodiment 42 | 13.89 | 18.59 | 0.656 | / | / |
| Embodiment 43 | 13.86 | 18.75 | 0.652 | / | / |
| Embodiment 44 | 13.80 | 19.08 | 0.651 | / | / |
| Embodiment 45 | 14.09 | 17.22 | 0.713 | / | / |
| Embodiment 46 | 14.05 | 17.76 | 0.710 | / | / |
| Embodiment 47 | 13.94 | 18.65 | 0.654 | / | / |
| Embodiment 48 | 13.81 | 19.71 | 0.639 | / | / |
| Embodiment 49 | 13.58 | 20.86 | 0.637 | / | / |
| Embodiment 50 | 13.54 | 21.23 | 0.621 | / | / |
| Embodiment 51 | 13.38 | 22.34 | 0.610 | / | / |
| Embodiment 52 | 13.25 | 23.19 | 0.602 | / | / |
| Embodiment 53 | 13.33 | 23.69 | 0.594 | / | / |
| Embodiment 54 | 13.02 | 24.49 | / | 0.523 | / |
| Embodiment 55 | 13.05 | 24.43 | / | 0.521 | / |
| Embodiment 56 | 13.49 | 21.67 | 0.618 | / | / |
| Embodiment 57 | 12.95 | 25.41 | / | 0.515 | / |
| Embodiment 58 | 14.17 | 16.97 | 0.735 | / | / |
| Embodiment 59 | 14.24 | 17.66 | 0.713 | / | / |
| Embodiment 60 | 13.9 | 19.13 | 0.651 | / | / |
| Embodiment 61 | 14.12 | 17.44 | 0.672 | / | / |
| Embodiment 62 | 13.92 | 18.68 | 0.652 | / | / |
| Embodiment 63 | 13.7 | 20.15 | 0.639 | / | / |
| Embodiment 64 | 13.56 | 21.64 | 0.619 | / | / |
| Embodiment 65 | 13.41 | 23.09 | 0.605 | / | / |
| Embodiment 66 | 13.3 | 24.76 | / | 0.519 | / |
| Embodiment 67 | 13.15 | 24.02 | / | 0.521 | / |
| Embodiment 68 | 13.12 | 24.21 | / | 0.519 | / |
| Embodiment 69 | 12.39 | 27.81 | / | 0.491 | / |
| Embodiment 70 | 12.31 | 29.42 | / | 0.488 | / |
| Embodiment 71 | 11.95 | 31.02 | / | / | 0.442 |
| Embodiment 72 | 12.01 | 30.51 | / | / | 0.448 |
| Embodiment 73 | 12.11 | 31.09 | / | / | 0.442 |
| Embodiment 74 | 12.39 | 29.39 | / | 0.488 | / |
| Embodiment 75 | 12.35 | 23.03 | 0.605 | / | / |
| Embodiment 76 | 14.32 | 22.38 | 0.610 | / | / |
| Embodiment 77 | 14.35 | 28.15 | / | 0.503 | / |
| Comparative | 13.8 | 14.9 | 0.803 | / | / |
| Embodiment 1 | | | | | |
| Comparative | 14.1 | 14.2 | 0.819 | / | / |
| Embodiment 2 | | | | | |

(2) Composition determination: The components were determined by high frequency inductively coupled plasma emission spectrometer (TCP-OES). The composition test results are shown in Table 4 below.

TABLE 4

| | R | R | Nd | Pr | RH | RH | Cu | Al | Ga | Co | Zr | Nb | Mn | M | M | B | Fe | C | O | N |
|---|---|---|---|---|---|---|---|---|---|---|---|---|---|---|---|---|---|---|---|---|
| No. | kind | dose | wt. % | wt. % | kind | wt. % | wt. % | wt. % | wt. % | wt. % | wt. % | wt. % | wt. % | kind | wt. % | wt. % | wt. % | wt. % | wt. % | wt. % |
| Embodi- | / | / | 21.648 | 8.849 | / | / | / | / | / | / | / | / | / | / | / | 0.948 | remainder | 0.1069 | 0.039 | 0.0482 |
| ment 1 | | | | | | | | | | | | | | | | | | | | |
| Embodi- | / | / | 19.649 | 10.849 | / | / | / | / | / | / | / | / | / | / | / | 0.947 | remainder | 0.1251 | 0.0412 | 0.0458 |
| ment 2 | | | | | | | | | | | | | | | | | | | | |
| Embodi- | / | / | 18.335 | 12.151 | / | / | / | / | / | / | / | / | / | / | / | 0.951 | remainder | 0.1532 | 0.0432 | 0.0439 |
| ment 3 | | | | | | | | | | | | | | | | | | | | |
| Embodi- | / | / | 16.349 | 14.152 | / | / | / | / | / | / | / | / | / | / | / | 0.952 | remainder | 0.1759 | 0.0468 | 0.0401 |
| ment 4 | | | | | | | | | | | | | | | | | | | | |
| Embodi- | / | / | 14.348 | 16.151 | / | / | / | / | / | / | / | / | / | / | / | 0.951 | remainder | 0.1835 | 0.0493 | 0.0375 |
| ment 5 | | | | | | | | | | | | | | | | | | | | |
| Embodi- | / | / | 13.348 | 17.152 | / | / | / | / | / | / | / | / | / | / | / | 0.947 | remainder | 0.1965 | 0.0523 | 0.0342 |
| ment 6 | | | | | | | | | | | | | | | | | | | | |
| Embodi- | / | / | 11.3481 | 19.15 | / | / | / | / | / | / | / | / | / | / | / | 0.951 | remainder | 0.2139 | 0.0558 | 0.0302 |
| ment 7 | | | | | | | | | | | | | | | | | | | | |
| Embodi- | / | / | 9.349 | 21.148 | / | / | / | / | / | / | / | / | / | / | / | 0.947 | remainder | 0.2248 | 0.0635 | 0.0251 |
| ment 8 | | | | | | | | | | | | | | | | | | | | |
| Embodi- | / | / | 7.351 | 23.149 | / | / | / | / | / | / | / | / | / | / | / | 0.947 | remainder | 0.2248 | 0.0635 | 0.0251 |
| ment 9 | | | | | | | | | | | | | | | | | | | | |
| Embodi- | / | / | 5.352 | 25.152 | / | / | / | / | / | / | / | / | / | / | / | 0.951 | remainder | 0.2379 | 0.0669 | 0.0223 |
| ment 10 | | | | | | | | | | | | | | | | | | | | |
| Embodi- | / | / | 3.348 | 27.148 | / | / | / | / | / | / | / | / | / | / | / | 0.947 | remainder | 0.2456 | 0.0685 | 0.0182 |
| ment 11 | | | | | | | | | | | | | | | | | | | | |
| Embodi- | / | / | 22.149 | 8.851 | / | / | 0.201 | / | / | / | / | / | / | / | / | 0.951 | remainder | 0.1072 | 0.0382 | 0.0482 |
| ment 12 | | | | | | | | | | | | | | | | | | | | |
| Embodi- | / | / | 18.849 | 12.15 | / | / | 0.302 | / | / | / | / | / | / | / | / | 1.011 | remainder | 0.1256 | 0.0442 | 0.0461 |
| ment 13 | | | | | | | | | | | | | | | | | | | | |
| Embodi- | / | / | 13.848 | 17.15 | / | / | 0.351 | / | / | / | / | / | / | / | / | 1.009 | remainder | 0.1537 | 0.0456 | 0.0442 |
| ment 14 | | | | | | | | | | | | | | | | | | | | |
| Embodi- | / | / | 10.851 | 20.15 | / | / | 0.451 | / | / | / | / | / | / | / | / | 1.008 | remainder | 0.1764 | 0.0492 | 0.0404 |
| ment 15 | | | | | | | | | | | | | | | | | | | | |
| Embodi- | / | / | 7.849 | 23.15 | / | / | 0.50 | / | / | / | / | / | / | / | / | 0.998 | remainder | 0.1843 | 0.0501 | 0.0378 |
| ment 16 | | | | | | | | | | | | | | | | | | | | |
| Embodi- | / | / | 22.149 | 8.848 | / | / | / | 0.021 | / | / | / | / | / | / | / | 1.011 | remainder | 0.1973 | 0.0529 | 0.0347 |
| ment 17 | | | | | | | | | | | | | | | | | | | | |
| Embodi- | / | / | 20.851 | 10.151 | / | / | / | 0.041 | / | / | / | / | / | / | / | 0.949 | remainder | 0.2147 | 0.0564 | 0.0307 |
| ment 18 | | | | | | | | | | | | | | | | | | | | |
| Embodi- | / | / | 18.849 | 12.148 | / | / | / | 0.101 | / | / | / | / | / | / | / | 0.948 | remainder | 0.2251 | 0.0588 | 0.029 |
| ment 19 | | | | | | | | | | | | | | | | | | | | |
| Embodi- | / | / | 16.848 | 14.149 | / | / | / | 0.202 | / | / | / | / | / | / | / | 0.948 | remainder | 0.2248 | 0.0641 | 0.0256 |
| ment 20 | | | | | | | | | | | | | | | | | | | | |
| Embodi- | / | / | 14.849 | 16.151 | / | / | / | 0.301 | / | / | / | / | / | / | / | 0.949 | remainder | 0.2379 | 0.0675 | 0.0228 |
| ment 21 | | | | | | | | | | | | | | | | | | | | |
| Embodi- | / | / | 13.852 | 17.151 | / | / | / | 0.401 | / | / | / | / | / | / | / | 0.949 | remainder | 0.2456 | 0.0691 | 0.0187 |
| ment 22 | | | | | | | | | | | | | | | | | | | | |
| Embodi- | / | / | 11.851 | 19.150 | / | / | / | 0.497 | / | / | / | / | / | / | / | 0.948 | remainder | 0.1761 | 0.0494 | 0.0397 |
| ment 23 | | | | | | | | | | | | | | | | | | | | |
| Embodi- | / | / | 10.851 | 20.152 | / | / | / | 0.602 | / | / | / | / | / | / | / | 0.951 | remainder | 0.184 | 0.0503 | 0.0371 |
| ment 24 | | | | | | | | | | | | | | | | | | | | |
| Embodi- | / | / | 8.852 | 22.151 | / | / | / | 0.702 | / | / | / | / | / | / | / | 0.949 | remainder | 0.1761 | 0.0494 | 0.0397 |
| ment 25 | | | | | | | | | | | | | | | | | | | | |
| Embodi- | / | / | 6.851 | 24.152 | / | / | / | 0.801 | / | / | / | / | / | / | / | 0.95 | remainder | 0.1846 | 0.05 | 0.0366 |
| ment 26 | | | | | | | | | | | | | | | | | | | | |
| Embodi- | / | / | 20.652 | 8.851 | / | / | / | / | 0.102 | / | / | / | / | / | / | 0.948 | remainder | 0.1069 | 0.0384 | 0.0476 |
| ment 27 | | | | | | | | | | | | | | | | | | | | |
| Embodi- | / | / | 19.652 | 9.85 | / | / | / | / | 0.2 | / | / | / | / | / | / | 0.981 | remainder | 0.1253 | 0.0444 | 0.0455 |
| ment 28 | | | | | | | | | | | | | | | | | | | | |
| Embodi- | / | / | 18.651 | 10.848 | / | / | / | / | 0.251 | / | / | / | / | / | / | 0.982 | remainder | 0.1534 | 0.0458 | 0.0436 |
| ment 29 | | | | | | | | | | | | | | | | | | | | |
| Embodi- | / | / | 17.652 | 11.848 | / | / | / | / | 0.302 | / | / | / | / | / | / | 0.985 | remainder | 0.1761 | 0.0494 | 0.0398 |
| ment 30 | | | | | | | | | | | | | | | | | | | | |
| Embodi- | / | / | 17.352 | 12.148 | / | / | / | / | 0.421 | / | / | / | / | / | / | 0.981 | remainder | 0.184 | 0.0503 | 0.0341 |
| ment 31 | | | | | | | | | | | | | | | | | | | | |
| Embodi- | / | / | 16.350 | 13.149 | / | / | / | / | 0.501 | / | / | / | / | / | / | 0.982 | remainder | 0.197 | 0.0531 | 0.0341 |
| ment 32 | | | | | | | | | | | | | | | | | | | | |
| Embodi- | / | / | 15.353 | 14.148 | / | / | / | / | 0.901 | / | / | / | / | / | / | 0.985 | remainder | 0.2144 | 0.0566 | 0.0301 |
| ment 33 | | | | | | | | | | | | | | | | | | | | |
| Embodi- | / | / | 9.352 | 20.148 | / | / | / | / | 1.402 | / | / | / | / | / | / | 0.981 | remainder | 0.2248 | 0.059 | 0.0284 |
| ment 34 | | | | | | | | | | | | | | | | | | | | |
| Embodi- | / | / | 8.351 | 21.148 | / | / | / | / | 1.552 | / | / | / | 0.01 | / | / | 0.982 | remainder | 0.2245 | 0.0643 | 0.025 |
| ment 35 | | | | | | | | | | | | | | | | | | | | |
| Embodi- | / | / | 14.335 | 17.149 | / | / | / | / | / | 0.501 | / | / | / | / | / | 0.985 | remainder | 0.1759 | 0.0468 | 0.0401 |
| ment 36 | | | | | | | | | | | | | | | | | | | | |
| Embodi- | / | / | 13.352 | 18.148 | / | / | / | / | / | 1.021 | / | / | / | / | / | 0.981 | remainder | 0.1835 | 0.0493 | 0.0375 |
| ment 37 | | | | | | | | | | | | | | | | | | | | |
| Embodi- | / | / | 12.352 | 19.148 | / | / | / | / | / | 2.501 | / | / | / | / | / | 1.010 | remainder | 0.1965 | 0.0523 | 0.0342 |
| ment 38 | | | | | | | | | | | | | | | | | | | | |
| Embodi- | / | / | 14.351 | 17.148 | / | / | / | / | / | / | 0.251 | / | / | / | / | 1.009 | remainder | 0.2139 | 0.0558 | 0.0302 |
| ment 39 | | | | | | | | | | | | | | | | | | | | |
| Embodi- | / | / | 13.352 | 18.149 | / | / | / | / | / | / | 0.301 | / | / | / | / | 1.011 | remainder | 0.2243 | 0.0582 | 0.0285 |
| ment 40 | | | | | | | | | | | | | | | | | | | | |
| Embodi- | / | / | 12.351 | 19.149 | / | / | / | / | / | / | 0.351 | / | / | / | / | 1.010 | remainder | 0.1072 | 0.0382 | 0.0482 |
| ment 41 | | | | | | | | | | | | | | | | | | | | |
| Embodi- | / | / | 14.35 | 17.148 | / | / | / | / | / | / | / | 0.251 | / | / | / | 1.009 | remainder | 0.2379 | 0.0669 | 0.0223 |
| ment 42 | | | | | | | | | | | | | | | | | | | | |
| Embodi- | / | / | 13.353 | 18.151 | / | / | / | / | / | / | / | 0.301 | / | / | / | 1.0011 | remainder | 0.2456 | 0.0685 | 0.0182 |
| ment 43 | | | | | | | | | | | | | | | | | | | | |
| Embodi- | / | / | 12.351 | 19.148 | / | / | / | / | / | / | / | 0.351 | / | / | / | 1.010 | remainder | 0.1072 | 0.0382 | 0.0482 |
| ment 44 | / | | | | | | | | | | | | | | | | | | | |
| Embodi- | / | / | 22.652 | 8.848 | / | / | 0.341 | 0.021 | / | / | / | / | / | / | / | 1.009 | remainder | 0.1256 | 0.0442 | 0.0461 |
| ment 45 | | | | | | | | | | | | | | | | | | | | |
| Embodi- | / | / | 21.353 | 10.149 | / | / | 0.382 | 0.041 | / | / | / | / | / | / | / | 1.010 | remainder | 0.1537 | 0.0456 | 0.0442 |
| ment 46 | | | | | | | | | | | | | | | | | | | | |
| Embodi- | / | / | 19.351 | 12.148 | / | / | 0.42 | 0.103 | / | / | / | / | / | / | / | 1.009 | remainder | 0.1764 | 0.0492 | 0.0404 |
| ment 47 | | | | | | | | | | | | | | | | | | | | |
| Embodi- | / | / | 17.352 | 14.151 | / | / | 0.441 | 0.202 | / | / | / | / | / | / | / | 1.011 | remainder | 0.1843 | 0.0501 | 0.0378 |
| ment 48 | | | | | | | | | | | | | | | | | | | | |
| Embodi- | / | / | 15.352 | 16.152 | / | / | 0.501 | 0.302 | / | / | / | / | / | / | / | 1.010 | remainder | 0.1973 | 0.0529 | 0.0347 |
| ment 49 | | | | | | | | | | | | | | | | | | | | |
| Embodi- | / | / | 14.352 | 17.152 | / | / | 0.34 | 0.403 | / | / | / | / | / | / | / | 1.010 | remainder | 0.2147 | 0.0564 | 0.307 |
| ment 50 | | | | | | | | | | | | | | | | | | | | |
| Embodi- | / | / | 12.352 | 19.148 | / | / | 0.381 | 0.501 | / | / | / | / | / | / | / | 1.009 | remainder | 0.2251 | 0.0588 | 0.029 |
| ment 51 | | | | | | | | | | | | | | | | | | | | |
| Embodi- | / | / | 11.351 | 20.148 | / | / | 0.42 | 0.602 | / | / | / | / | / | / | / | 1.011 | remainder | 0.2248 | 0.0641 | 0.0256 |
| ment 52 | | | | | | | | | | | | | | | | | | | | |
| Embodi- | / | / | 9.352 | 22.149 | / | / | 0.341 | 0.502 | 0.102 | / | / | / | / | / | / | 1.010 | remainder | 0.2379 | 0.0675 | 0.0228 |
| ment 53 | | | | | | | | | | | | | | | | | | | | |
| Embodi- | / | / | 7.353 | 24.148 | / | / | 0.401 | 0.602 | 0.302 | / | / | / | / | / | / | 1.009 | remainder | 0.2456 | 0.0691 | 0.0187 |
| ment 54 | | | | | | | | | | | | | | | | | | | | |
| Embodi- | / | / | 13.653 | 17.152 | / | / | 0.501 | 0.81 | 0.421 | / | / | / | / | / | / | 1.010 | remainder | 0.1761 | 0.0494 | 0.0398 |
| ment 55 | | | | | | | | | | | | | | | | | | | | |
| Embodi- | / | / | 8.651 | 22.151 | / | / | 0.341 | 0.501 | 0.102 | / | 0.25 | / | / | / | / | 1.009 | remainder | 0.184 | 0.0503 | 0.0371 |
| ment 56 | | | | | | | | | | | | | | | | | | | | |
| Embodi- | / | / | 6.652 | 24.151 | / | / | 0.501 | 0.802 | 0.302 | / | 0.30 | / | / | / | / | 1.011 | remainder | 0.1761 | 0.0494 | 0.0397 |
| ment 57 | | | | | | | | | | | | | | | | | | | | |
| Embodi- | / | / | 21.951 | 8.846 | / | / | 0.34 | 0.01 | 0.251 | / | / | / | / | / | / | 1.010 | remainder | 0.1846 | 0.05 | 0.0366 |
| ment 58 | | | | | | | | | | | | | | | | | | | | |
| Embodi- | / | / | 20.652 | 10.148 | / | / | 0.381 | 0.021 | 0.302 | / | / | / | / | / | / | 0.962 | remainder | 0.1069 | 0.0384 | 0.0476 |
| ment 59 | | | | | | | | | | | | | | | | | | | | |
| Embodi- | / | / | 18.652 | 12.15 | / | / | 0.421 | 0.03 | 0.42 | / | / | / | / | / | / | 0.958 | remainder | 0.1253 | 0.0444 | 0.0455 |
| ment 60 | | | | | | | | | | | | | | | | | | | | |
| Embodi- | / | / | 16.651 | 14.147 | / | / | 0.382 | 0.042 | 0.102 | / | / | / | / | / | / | 0.958 | remainder | 0.1534 | 0.0458 | 0.0436 |
| ment 61 | | | | | | | | | | | | | | | | | | | | |
| Embodi- | / | / | 14.652 | 16.148 | / | / | 0.4202 | 0.102 | 0.151 | / | / | / | / | / | / | 0.958 | remainder | 0.1761 | 0.0494 | 0.0398 |
| ment 62 | | | | | | | | | | | | | | | | | | | | |
| Embodi- | / | / | 13.651 | 17.149 | / | / | 0.441 | 0.202 | 0.251 | / | / | / | / | / | / | 0.958 | remainder | 0.184 | 0.0503 | 0.0372 |
| ment 63 | | | | | | | | | | | | | | | | | | | | |
| Embodi- | / | / | 11.652 | 19.152 | / | / | 0.502 | 0.302 | 0.301 | / | / | / | / | / | / | 0.961 | remainder | 0.197 | 0.0531 | 0.0341 |
| ment 64 | | | | | | | | | | | | | | | | | | | | |
| Embodi- | / | / | 10.651 | 20.149 | / | / | 0.451 | 0.402 | 0.421 | / | / | / | / | / | / | 0.985 | remainder | 0.2144 | 0.0566 | 0.0301 |
| ment 65 | | | | | | | | | | | | | | | | | | | | |
| Embodi- | / | / | 8.052 | 22.149 | / | / | 0.502 | 0.502 | 0.502 | / | / | / | / | / | / | 1.009 | remainder | 0.2248 | 0.059 | 0.0284 |
| ment 66 | | | | | | | | | | | | | | | | | | | | |
| Embodi- | / | / | 12.651 | 18.151 | / | / | 0.401 | 0.602 | 0.401 | 2.501 | 0.302 | / | / | Cr | 0.05 | 1.011 | remainder | 0.2245 | 0.0643 | 0.025 |
| ment 67 | | | | | | | | | | | | | | | | | | | | |
| Embodi- | / | / | 12.652 | 18.152 | / | / | 0.403 | 0.601 | 0.401 | 2.501 | 0.302 | / | / | Cr | 0.12 | 1.012 | remainder | 0.1062 | 0.039 | 0.0482 |
| ment 68 | | | | | | | | | | | | | | | | | | | | |
| Embodi- | / | / | 13.649 | 17.151 | Dy | 1.51 | 0.403 | 0.302 | 0.301 | 2.502 | 0.301 | / | / | / | / | 1.011 | remainder | 0.1251 | 0.0412 | 0.0458 |
| ment 69 | | | | | | | | | | | | | | | | | | | | |
| Embodi- | / | / | 12.649 | 18.152 | Dy | 2.011 | 0.4 | 0.298 | 0.301 | 2.502 | 0.302 | / | / | / | / | 0.958 | remainder | 0.1532 | 0.0432 | 0.0439 |
| ment 70 | | | | | | | | | | | | | | | | | | | | |
| Embodi- | / | / | 11.651 | 19.152 | Dy | 2.511 | 0.41 | 0.351 | 0.30 | 2.501 | 0.303 | / | / | / | / | 0.961 | remainder | 0.1759 | 0.0468 | 0.0401 |
| ment 71 | | | | | | | | | | | | | | | | | | | | |
| Embodi- | / | / | 11.652 | 19.151 | Dy | 2.512 | 0.402 | 0.451 | 0.302 | 2.501 | 0.303 | / | / | / | / | 0.962 | remainder | 0.1835 | 0.0493 | 0.0375 |
| ment 72 | | | | | | | | | | | | | | | | | | | | |
| Embodi- | / | / | 13.651 | 17.152 | Tb | 1.991 | 0.402 | 0.302 | 0.301 | 2.505 | 0.303 | / | / | / | / | 0.958 | remainder | 0.1965 | 0.0523 | 0.0342 |
| ment 73 | | | | | | | | | | | | | | | | | | | | |
| Embodi- | / | / | 12.650 | 18.151 | Tb | 1.212 | 0.402 | 0.302 | 0.301 | 2.501 | 0.308 | / | / | / | / | 0.961 | remainder | 0.2139 | 0.0558 | 0.0302 |
| ment 74 | | | | | | | | | | | | | | | | | | | | |
| Embodi- | Ce | 0.29 | 11.352 | 18.152 | Tb | 1.219 | 0.41 | 0.601 | 0.399 | 2.491 | 0.298 | / | / | / | / | 0.962 | remainder | 0.2234 | 0.0582 | 0.0085 |
| ment 75 | | | | | | | | | | | | | | | | | | | | |
| Embodi- | / | / | 21.647 | 8.848 | Dy | 0.62 | / | / | / | / | / | / | / | / | / | 0.947 | remainder | 0.1075 | 0.041 | 0.0485 |
| ment 76 | | | | | | | | | | | | | | | | | | | | |
| Embodi- | / | / | 21.649 | 8.846 | Tb | 0.58 | / | / | / | / | / | / | / | / | / | 0.946 | remainder | 0.1069 | 0.0391 | 0.0486 |
| ment 77 | | | | | | | | | | | | | | | | | | | | |
| Compara- | / | / | 21.998 | 7.988 | / | / | / | / | / | / | / | / | / | / | / | 0.958 | remainder | 0.2248 | 0.0635 | 0.0251 |
| tive | | | | | | | | | | | | | | | | | | | | |
| Embodi- | | | | | | | | | | | | | | | | | | | | |
| ment 1 | | | | | | | | | | | | | | | | | | | | |
| Compara- | / | / | 22.094 | 7.989 | / | / | 0.401 | 0 | 0.403 | 2.489 | 0.289 | / | / | Cr | 0.121 | 0.961 | remainder | 0.2379 | 0.0669 | 0.0223 |
| tive | | | | | | | | | | | | | | | | | | | | |
| Embodi- | | | | | | | | | | | | | | | | | | | | |
| ment 2 | | | | | | | | | | | | | | | | | | | | |

(3) Fe-EPMA detection: The vertical orientation surfaces of the RTB-based magnet materials in Embodiments 1, 2, 11, 12, 21, 23, 34, 35, 39, 43, 51, 52, 60, 63, 68, 69 and Comparative Embodiments 1 and 2 in Table 4 were polished. Field emission electron probe microanalyzer (FE-EPMA) (JEOL, 8530F) was used for detection.

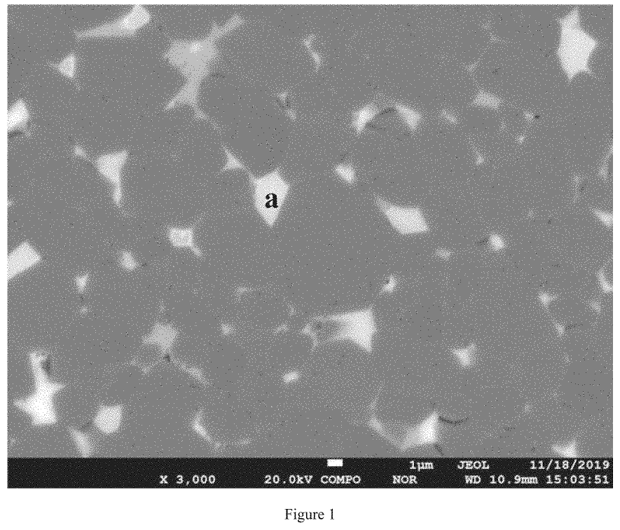

The position of intergranular triangle region in Embodiment 68 (as shown at position a in FIG. 1) was investigated for composition, and the relative volume ratio of the phase of the triangle region rare-earth-rich phase) to all phases of the observation surface (main phase, the grain boundary phase and the rare-earth-rich phase) was determined, which can be found that in the samples containing high Pr and high C, the ration of the phases formed in intergranular region was relatively low, which was not seen in the samples containing low Pr. The specific test results are shown in Table 5 below.

TABLE 5

| | | | | Proportion of |
|---|---|---|---|---|
| | | | | phases in the |
| | Intergranular triangle region | | | Intergranular- |
| | R′ | Ga + Cu | O | triangle region |
| No. | (mass ratio) | (mass ratio) | (mass ratio) | / |
| Embodiment 1 | 85.4 | / | 14.6 | 4.6 |
| Embodiment 2 | 85.3 | / | 14.7 | 5.3 |
| Embodiment 11 | 85.3 | / | 14.7 | 4.8 |
| Embodiment 12 | 85.4 | 0.9 (Cu) | 13.7 | 3.2 |
| Embodiment 21 | 85.3 | / | 14.7 | 3.3 |
| Embodiment 23 | 85.3 | / | 14.7 | 4.6 |
| Embodiment 34 | 85.2 | 0.4 (Ga) | 14.4 | 4.8 |
| Embodiment 35 | 85 | 0.6 (Ga) | 14.4 | 3.7 |
| Embodiment 39 | 85.2 | / | 14.8 | 3.2 |
| Embodiment 43 | 85.3 | / | 14.7 | 3.3 |
| Embodiment 51 | 84.9 | 0.8 (Cu) | 14.3 | 4.6 |
| Embodiment 52 | 84.9 | 0.6 (Cu) | 14.5 | 4.8 |
| Embodiment 60 | 84.35 | 0.3 (Cu) + 0.6 (Ga) | 14.75 | 3.2 |
| Embodiment 63 | 84.8 | 0.4 (Cu) + 0.4 (Ga) | 14.4 | 3.3 |
| Embodiment 68 | 85.85 | 0.4 (Cu) + 0.5 (Ga) | 13.25 | 4.6 |
| Embodiment 69 | 84.8 | 0.4 (Cu) + 0.6 (Ga) | 14.2 | 4.8 |
| Comparative | 85.3 | / | 14.7 | 9.8 |
| Embodiment 1 | | | | |
| Comparative | 84.7 | 0.4 (Cu) + 0.6 (Ga) | 14.3 | 12.5 |
| Embodiment 2 | | | | |

Note:
The mass ratio of R′, Ga, Cu and O in the intergranular triangle region refers to the mass percentage in the total mass of elements in the intergranular triangle region; the volume ratio of the phase in intergranular triangle region refers to the percentage of the volume of the phase in intergranular triangle region with respect to the sum of the volume of the &lddquo;main phase, the grain boundary phase and the intergranular triangle region”.

1. A RTB-based permanent magnet material, wherein, the RTB-based permanent magnet material comprises the following components by mass percentage:
R′: 29.5-33.5 wt. %, wherein: R′ is a rare earth element and R′ comprises Pr; the content of Pr is ≥8.85 wt. %;
C: 0.106-0.26 wt. %;
O: ≤0.07 wt. %;
X: 0-5.0 wt. %, X is one or more of Cu, Al, Ga, Co, Zr, Ti, Nb and Mn;
B: 0.90-1.2 wt. %;
Fe: 61.4-69.5 wt. %.

2-10. (canceled)

11. The RTB-based permanent magnet material according to claim 1, wherein, the RTB-based permanent magnet material includes a main phase, a grain boundary phase, and an intergranular triangle region, and the percentage of the volume of the intergranular triangle region to the sum of the volume of the “main phase, the grain boundary phase and the intergranular triangle region” is ≤9.0%.

12. The RTB-based permanent magnet material according to claim 1, wherein, R′ further comprises Nd; or, R′ further comprises R, R is a rare earth element besides Pr and Nd.

13. The RTB-based permanent magnet material according to claim 1, wherein, R′ also comprises a heavy rare earth element RH; wherein, the kind of RH is selected from the group consisting of Dy and Tb.

14. The RTB-based permanent magnet material according to claim 1, wherein, the RTB-based permanent magnet material further comprises M, and M is one or more of Ni, Zn, Ag, In, Sn, Bi, V, Cr, Hf, Ta, and W; the content of M is 0-0.15 wt. %, but not 0, the percentage refers to the mass percentage in the RTB-based permanent magnet material.

15. The RTB-based permanent magnet material according to claim 1, wherein, the RTB-based permanent magnet material further comprises nitrogen element N, the content of N≤0.05 wt. %, the percentage refers to the mass percentage in the RTB-based permanent magnet material.

16. The RTB-based permanent magnet material according to claim 1, wherein, X is Cu, Al, Ga, Co, Zr, Ti or Nb, or “Cu and Al”, “Ga and Mn”, “Cu, Al and Ga”, “Cu, Al, Ga and Zr”, “Cu, Al, Ga and Co” or “Cu, Al, Ga, Zr and Co”.

17. The RTB-based permanent magnet material according to claim 1, wherein, the RTB-based permanent magnet material comprises the following components: R′: 29.5-33.5 wt. %, Pr≥8.85 wt. %, C: 0.106-0.25 wt. %, O: ≤0.07 wt. %, B: 0.94-1.1 wt. %, Fe: 61.4-69.3 wt. %, the percentage refers to the mass percentage in the RTB-based permanent magnet material; or, the RTB-based permanent magnet material comprises the following components: R′: 29.5-33.5 wt. %, Pr≥8.85 wt. %, C: 0.106-0.25 wt. %, O: ≤0.07 wt. %, Cu: 0.2-0.51 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C: 0.106-0.25 wt. %, O: ≤0.07 wt. %, Al: 0-0.81 wt. %, but not 0, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C:0.106-0.25 wt. %, O: ≤0.07 wt. %, Ga: 0.1-1.85 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C: 0.106-0.25 wt. %, O: ≤0.07 wt. %, Co: 0.0-3.0 wt. %, but not 0, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C:0.106-0.25 wt. %, O: ≤0.07 wt. %, Zr: 0.25-0.35 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C: 0.106-0.25 wt. %, O: ≤0.07 wt. %, Nb: 0.25-0.35 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C: 0.106-0.25 wt. %, O: ≤0.07 wt. %, Cu: 0.34-0.51 wt. %, Al: 0-0.81 wt. %, but not 0, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C: 0.106-0.25 wt. %, O: ≤0.07 wt. %, Cu: 0.34-0.51 wt. %, Al: 0-0.81 wt. %, but not 0, Ga: 0.1-0.5 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C: 0.106-0.25 wt. %, O: ≤0.07 wt. %, Cu: 0.34-0.51 wt. %, Al: 0.25-0.81 wt. %, Ga: 0.1-0.42 wt. %, Zr: 0.25-0.30 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, C:0.106-0.25 wt. %, O: ≤0.07 wt. %, Cu: 0.34-0.51 wt. %, Al: 0.25-0.81 wt. %, Ga: 0.1-0.41 wt. %, Co: 0.0-3.0 wt. %, Zr: 0.25-0.30 wt. %, Cr: 0.05-0.12 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, RH: 0.5-2.6 wt. %, C: 0.106-0.25 wt. %, O: ≤0.07 wt. %, Cu: 0.34-0.51 wt. %, Al: 0.25-0.81 wt. %, Ga: 0.1-0.41 wt. %, Co: 0.0-3.0 wt. %, Zr: 0.25-0.30 wt. %, B: 0.94-1.1 wt. %, Fe: 61.4-69.3 wt. %, the percentage refers to the mass percentage in the RTB-based permanent magnet material;
or, the RTB-based permanent magnet material comprises the following components: R′: 29.5-33.5 wt. %, Pr≥8.85 wt. %, Ce: 0-1 wt. %, RH: 0.5-2.6 wt. %, C: 0.106-0.25 wt. %, O: ≤0.07 wt. %, Cu: 0.34-0.51 wt. %, Al: 0.25-0.81 wt. %, Ga: 0.1-0.41 wt. %, Co: 0.0-3.0 wt. %, Zr: 0.25-0.30 wt. %, B: 0.94-1.1 wt. %, Fe: 61.4-69.3 wt. %, the percentage refers to the mass percentage in the RTB-based permanent magnet material.

18. An application of the RTB-based permanent magnet material according to claim 1 as electronic components.

19. A preparation method for RTB-based permanent magnet material, wherein, the preparation method comprises the following steps: the molten liquid of the raw material composition of the RTB-based permanent magnet material is subjected to casting, hydrogen decrepitation and pulverization to obtain a powder, and the powder is mixed with dispersant, and then pressed, formed, sintered and aged; wherein:
(1) the raw material composition of RTB-based permanent magnet material comprises the following components by mass percentage:
R′: 29.5-33.5 wt. %, R′ is a rare earth element, R′ comprises Pr, the content oo Pr is ≥8.85 wt. %;
X: 0-5.0 wt. %, X is one or more of Cu, Al, Ga, Co, Zr, Ti, Nb and Mn;
B: 0.90-1.2 wt. %;
Fe: 61.4-69.5 wt. %;
(2) in the process of pulverization, O≤60 ppm in the pulverization atmosphere;
(3) in the pressing process, O≤40 ppm in the pressing atmosphere;
(4) the dispersant comprises element C, and the mass percentage of the dispersant in the mixed powder is 0.04-0.2%.

20. The preparation method of RTB-based permanent magnet material according to claim 19, wherein, R′ further comprises Nd; or R′ further comprises R, R is a rare earth element besides Pr and Nd.

21. The preparation method of RTB-based permanent magnet material according to claim 19, wherein, R′ further comprises a heavy rare earth element RH; the kind of RH is selected from the group consisting of Dy and Tb.

22. The preparation method of RTB-based permanent magnet material according to claim 19, wherein, X is Cu, Al, Ga, Co, Zr, Ti or Nb, or, “Cu and Al”, “Ga and Mn”, “Cu, Al and Ga”, “Cu, Al, Ga and Zr”, “Cu, Al, Ga and Co” or “Cu, Al, Ga, Zr and Co”.

23. The preparation method of RTB-based permanent magnet material according to claim 19, wherein, when X comprises Cu, the content of the Cu is 0.2-0.5 wt. %;
or, when the X comprises Al, the content of Al is 0-0.8 wt. %, but not 0;
or, when the X comprises Ga, the content of Ga is 0.0-1.85 wt. %, but not 0;
or, when the X comprises Co, the content of Co is 0.0-3.0 wt. %, but not 0;
or, when the X comprises Zr, the content of Zr is 0.25-0.35 wt. %;
or, when the X comprises Nb, the content of Nb is 0.25-0.35 wt. %;
or, when the X comprises Mn, the content of Mn is 0.0-0.03 wt. %, but not 0;
the percentage refers to the mass percentage in the raw material composition of the RTB-based permanent magnet material.

24. The preparation method of RTB-based permanent magnet material according to claim 19, wherein, the RTB-based permanent magnet material further comprises M, M is one or more of Ni, Zn, Ag, In, Sn, Bi, V, Cr, Hf, Ta and W; the content of M is 0-0.15 wt. %, but not 0, and the percentage refers to the mass percentage in the raw material composition of the RTB-based permanent magnet material.

25. The preparation method of RTB-based permanent magnet material according to claim 19, wherein, the molten liquid of the raw material composition of the RTB-based permanent magnet material is prepared by the following method: melting in a vacuum induction melting furnace; the vacuum degree of the melting furnace is 5×10⁻² Pa; the melting temperature is below 1500° C.;
or, the casting process is carried out as follows: cooling at a rate of 10²° C./s-10⁴° C./s in an Ar atmosphere;
or, the pulverization is jet mill pulverization;
or, the sintering is also preceded by preheating;
or, the temperature of the sintering is 1040-1090° C.;
or, the treatment temperature of the aging treatment is 500-650° C.;
or, in the aging treatment, the heating rate of heating to 500-650° C. is 3-5° C./min.

26. The preparation method of RTB-based permanent magnet material according to claim 19, wherein, the grain boundary diffusion treatment is also carried out after sintering and before the aging treatment; wherein, the grain boundary diffusion treatment is carried out according to the following steps, attaching substance containing Tb, Dy, or “Tb and Dy” to the surface of the RTB-based permanent magnet material by evaporating, coating or sputtering, then carrying out diffusion heat treatment.

27. The preparation method of RTB-based permanent magnet material according to claim 19, wherein, during the process of pulverization, the content of oxygen O in the pulverization atmosphere is 0-50 ppm;
or, the dispersant is selected from the group consisting of a lubricant and an antioxidant;
or, the content of the dispersant is 0.04-0.14%, the percentage refers to the mass percentage with respect to the total mass of the mixed powder;
or, during the pressing process, the content of oxygen O in the pressing atmosphere is 10-30 ppm.

28. A RTB-based permanent magnet material prepared by the preparation method of RTB-based permanent magnet material according to claim 19.

29. An application of the RTB-based permanent magnet material according to claim 28 as electronic components.
